(19) United States
(12) Patent Application Publication
(10) Pub. No.: US 2026/0288736 A1
(43) Pub. Date: Sep. 24, 2026

(54) SYSTEM

(71) Applicant: SoftBank Group Corp., Tokyo (JP)

(72) Inventor: Nobuyuki KUROMATSU, Tokyo (JP)

(73) Assignee: SoftBank Group Corp., Tokyo (JP)

(21) Appl. No.: 19/567,071

(22) Filed: Mar. 14, 2026

(30) Foreign Application Priority Data
Mar. 19, 2025 (JP) 2025-045038

(51) Int. Cl. G06F 16/2457; G06F 16/29

(52) U.S. Cl. CPC G06F 16/24578; G06F 16/29

(57) ABSTRACT

A system includes a processor that is configured to receive input information from a user, collect data from a plurality of information sources, identify a region suitable for a preference of the user based on the collected data, generate a prompt for instructing a generative AI model to predict a region that is optimal for a condition of the user, input the prompt to the generative AI model to obtain a prediction result, and cause a proposal result based on the prediction result to be displayed through a user interface.

### CROSS-REFERENCE TO RELATED APPLICATION

This application is based on and claims priority under 35 USC 119 from Japanese Patent Application No. 2025-045038 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for recommending residential areas or regions to users typically rely on manually designed scoring rules or static matching logic based on limited structured data, such as basic geographic attributes or simple demographic statistics. Such systems often fail to utilize diverse and continuously updated information available on the Internet, including public databases, social media, review sites, and local information sources, and therefore cannot adequately reflect real-time changes in safety, commercial activities, or local atmosphere. Moreover, in many cases, user preferences are handled only as simple, explicit inputs, and implicit preferences that can be inferred from user behavior history are not effectively used. As a result, the recommended regions may not match the user's true preferences or conditions, and the user must spend considerable time manually searching and comparing candidate regions. There is therefore a need for a system that can integrate heterogeneous data from multiple information sources, accurately capture explicit and implicit user preferences, and generate highly tailored region proposals by leveraging generative AI models.

### SUMMARY

In order to solve the foregoing problems, a system is provided that comprises a processor, wherein the processor is configured to receive input information from a user, collect data from a plurality of information sources, identify a region suitable for a preference of the user based on the collected data, generate a prompt for instructing a generative AI model to predict a region that is optimal for a condition of the user, input the prompt to the generative AI model to obtain a prediction result, and cause a proposal result based on the prediction result to be displayed through a user interface. The processor is further configured to estimate the preference of the user based on direct input from the user or based on a behavior history of the user, and to generate the prompt based on the estimated preference. In addition, the processor is configured to obtain the collected data via the Internet from at least a public database, social media, a review site, and a regional information source, and to analyze the obtained data to generate the prompt. By dynamically generating prompts that reflect both multi-source environmental data and user-specific preferences and conditions, and by using a generative AI model to perform prediction, the system can provide highly personalized and up-to-date region proposals that effectively reduce the user's search burden and improve the accuracy and usefulness of recommended regions.

The term “processor” refers to any hardware or combination of hardware and software that is capable of executing instructions, including but not limited to a central processing unit (CPU), a microprocessor, a microcontroller, a graphics processing unit (GPU), a digital signal processor (DSP), or a plurality of such components operating in cooperation.

The term “user” refers to a person or an entity that operates a terminal device or otherwise interacts with the system to request, receive, or utilize region recommendations.

The term “input information” refers to data provided by the user to the system, including but not limited to explicit preference settings, constraints, conditions, profile data, or any other parameters relevant to recommending a region.

The term “plurality of information sources” refers to two or more distinct data providers or data repositories from which the system obtains data, including but not limited to public databases, social media services, review sites, and regional information sources.

The term “region” refers to a geographical area that can be proposed as a candidate for living or other purposes, including but not limited to a neighborhood, district, municipality, city, or area around a transportation node such as a station.

The term “preference of the user” refers to a user's liking, priority, or requirement regarding attributes of a region, such as safety, presence of shops, atmosphere, availability and characteristics of supermarkets, or other environmental or lifestyle factors.

The term “condition of the user” refers to one or more circumstances or requirements associated with the user, including but not limited to budget, family composition, commuting needs, lifestyle constraints, or other situational factors that influence suitability of a region.

The term “generative AI model” refers to a machine-learning model that generates output content, such as text, based on input data, including but not limited to large language models, transformer-based models, or other neural network models configured to generate prediction results from prompts.

The term “prompt” refers to a structured or unstructured input text, data object, or command sequence supplied to the generative AI model, which specifies instructions, conditions, or context for the model to generate a prediction result regarding one or more regions.

The term “prediction result” refers to an output generated by the generative AI model in response to the prompt, including but not limited to a ranking, score, selection, or description of one or more regions that are estimated to be optimal or suitable for the user.

The term “proposal result” refers to information presented to the user based on the prediction result, including but not limited to recommended regions, associated explanations, rankings, scores, or other guidance to assist the user in selecting a region.

The term “user interface” refers to any interface through which the user interacts with the system and receives the proposal result, including but not limited to graphical user interfaces on terminals, web pages, mobile applications, or voice-based interfaces.

The term “behavior history of the user” refers to logged data representing past actions or activities of the user, including but not limited to visited locations, accessed content, purchased items, search history, or usage logs that can be used to infer user preferences.

The term “public database” refers to a database that is accessible via the Internet and that provides data such as crime statistics, demographic information, infrastructure information, or other public records that can be associated with regions.

The term “social media” refers to online services or platforms that allow users to create, share, or interact with content, where posts, reactions, or other signals can be analyzed to derive information about regions, including atmosphere, popularity, or trends.

The term “review site” refers to an online service or platform where users post ratings, reviews, or comments about shops, restaurants, supermarkets, or other facilities, and from which information such as new shop openings, quality, variety, and price levels can be derived.

The term “regional information source” refers to an information provider that supplies data specifically related to a local area, including but not limited to local news websites, municipal information portals, community bulletin boards, or region-specific data feeds.

The term “analyze the obtained data” refers to processing the collected data using one or more techniques such as parsing, filtering, aggregating, normalizing, scoring, or applying statistical or machine-learning methods to generate information usable in the prompt.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

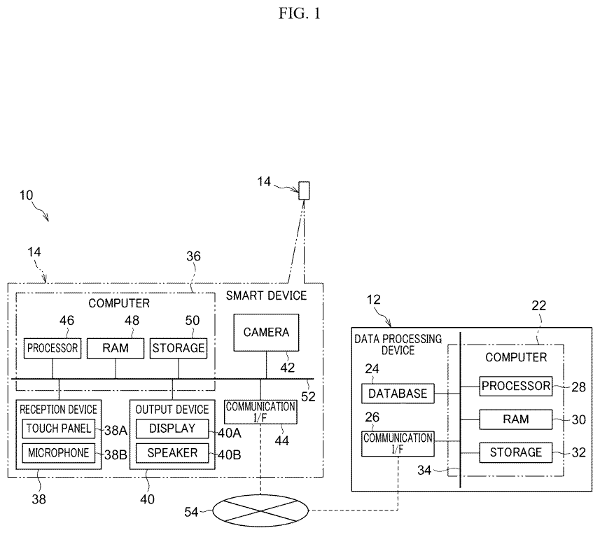

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

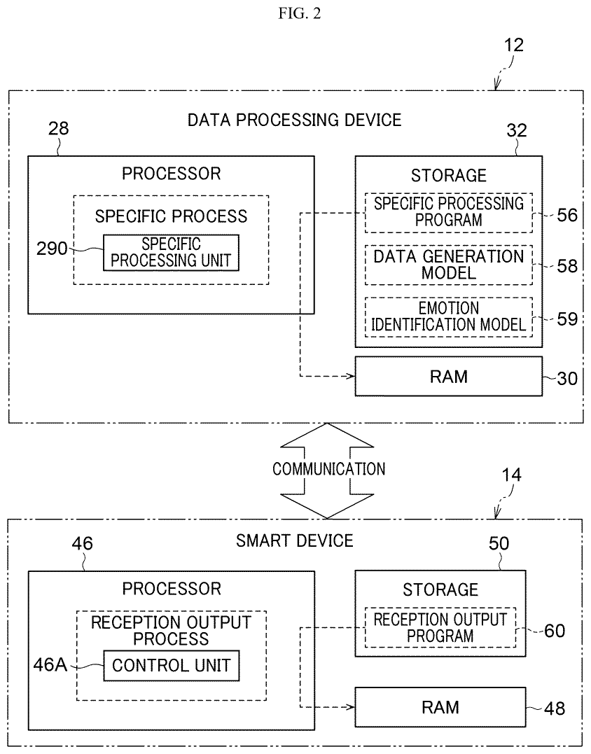

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented recommendation systems for residential area selection suffer from several technical limitations in how they acquire, structure, and utilize heterogeneous external data and user preference information. In typical systems, server-side processes either apply fixed heuristic scoring or simple rule-based filtering to data that is partially structured and partially unstructured, leading to inefficient use of processing resources and network bandwidth, as well as suboptimal data representations for downstream machine learning or generative models.

First, conventional systems generally treat user preference information as coarse parameters or category selections, without converting rich, free-text input and multi-dimensional importance weights into a unified, machine-readable feature representation. As a result, server resources are not effectively leveraged to generate structured feature vectors that accurately capture trade-offs among different attributes such as safety and availability of commercial facilities. This causes the server to perform repeated and redundant computations when adapting rankings for minor changes in user preferences, reducing throughput and scalability.

Second, in many existing architectures, external region-related data such as crime statistics and commercial facility data obtained via networked data sources is processed in an ad hoc manner, often storing verbose or redundant raw data instead of normalized, region-based feature data. This leads to inefficient memory usage and increased processor load when repeatedly transforming the same raw data into usable indicators. In addition, the absence of a standardized, machine-readable intermediate representation complicates the integration with downstream artificial intelligence models, causing additional pre-processing steps and increasing latency.

Third, when generative AI models are used, conventional systems typically pass loosely formulated natural language prompts that do not include explicit, structured feature vectors or clear instructions regarding output format. Consequently, the AI model's output may contain hallucinated items, inconsistent ranking formats, or explanations that cannot be reliably parsed by the server. This forces the server to perform expensive and error-prone text post-processing. Furthermore, because ranked recommendations and their explanations are not tightly bound to the underlying feature data (for example, safety indices and aggregated counts of facilities), the system cannot systematically associate numerical indicators with AI-generated reasoning, thereby limiting the reliability and auditability of the recommendations.

Therefore, there is a need for an improved computer-implemented technique in which a server efficiently (i) acquires user preference information as structured data, including free-text and weighted parameters; (ii) collects and normalizes heterogeneous external data into region-based feature vectors with computed indices; (iii) generates a machine-readable prompt sentence that embeds the feature vectors and explicit instructions for a generative AI model; and (iv) parses machine-readable AI output to produce consistent, ranked proposal results enriched with both numerical indicators and explanatory reasons. Such a technique should improve the way processors and memory structures on the server side are utilized, reduce redundant processing, and provide a robust pipeline for integrating generative AI into the recommendation workflow in a deterministic and parseable manner.

The specific processing by the specific processing unit 290 of the data processing device 12 in Example 1 is realized by the following means.

The present invention provides a server comprising a processor and a memory storing instructions that, when executed by the processor, cause the server to receive, via a user interface, input information regarding residential conditions from a client device and acquire the input information as structured data including user free-text, numerical parameters, and weight information for evaluation items; to acquire, via a communication network, raw region-related data from a plurality of external information sources, including crime occurrence information and commercial facility information, based on the structured data; to generate, by executing data processing operations on the raw region-related data, region-based feature data by calculating a safety index from the crime occurrence information, aggregating a number of commercial facilities opened within a predetermined period from the commercial facility information, and integrating the safety index and the aggregated number of commercial facilities; to generate, for each region, a feature vector including a weighted composite value by applying the weight information in the structured data to the feature data and to generate a prompt sentence including a machine-readable structured description representing the feature vector and natural language describing the residential conditions of the user, the prompt sentence further including explicit instructions specifying a ranking format and explanatory-reason format for regions for a generative AI model; to input the prompt sentence to the generative AI model and obtain, from the generative AI model, machine-readable prediction result data including, for each of a plurality of regions, a region identifier, a rank indicating a degree of suitability for the residential conditions of the user, and an explanatory reason; to parse the machine-readable prediction result data and associate the prediction result data with the region-based feature data so as to generate proposal result data including, for each recommended region, the safety index, the aggregated number of commercial facilities, and the explanatory reason; and to cause the user interface to display the proposal result data on the client device. This enables an improved computer-implemented recommendation process in which heterogeneous external data and rich user preference information are transformed into structured feature vectors and machine-readable prompt sentences optimized for a generative AI model, thereby reducing redundant server-side computations, improving the determinism and parseability of AI outputs, and enhancing the efficiency and reliability of generating ranked residential area proposals with associated numerical indices and explanations.

The term “structured data” refers to data that is organized into a predefined format with explicitly named fields and data types, such as key-value pairs or tabular entries, enabling deterministic parsing and processing by a computing device.

The term “external information source” refers to any remotely accessible data provider, including but not limited to public databases, online services, social platforms, and review services, that can be accessed via a communication network to obtain region-related data.

The term “raw region-related data” refers to data acquired in an original or minimally processed form from external information sources, the data including information associated with geographic units such as areas, districts, or transportation nodes.

The term “crime occurrence information” refers to data indicating events classified as crimes within specified geographic units and time periods, such as counts, categories, and timestamps of reported incidents.

The term “commercial facility information” refers to data representing commercial establishments within specified geographic units, including at least the type of establishment, location, and, optionally, attributes such as opening date, rating, or review count.

The term “safety index” refers to a numerical indicator calculated from crime occurrence information to represent a relative level of safety for a geographic unit, the indicator being derived through a predetermined computation such as normalization or scaling of crime rates.

The term “aggregated number of commercial facilities” refers to a numerical value obtained by grouping commercial facility information by geographic unit and counting facilities that satisfy predetermined criteria, such as being opened within a specified period.

The term “feature data” refers to data that represents, for each geographic unit, one or more computed attributes, including at least a safety index and an aggregated number of commercial facilities, structured to be used as input for further computational processing.

The term “feature vector” refers to an ordered collection of numerical or categorical feature values for a single geographic unit, derived from feature data and optionally including a weighted composite value based on user preference weights.

The term “weighted composite value” refers to a numerical value computed by combining multiple feature values for a geographic unit using one or more weight parameters that indicate relative importance of the corresponding features.

The term “weight information” refers to data that specifies importance levels or priorities for evaluation items, such as safety or availability of commercial facilities, the data being used to weight corresponding feature values or to condition a generative AI model.

The term “residential conditions” refers to requirements, preferences, or constraints specified by a user for selecting a place to live, including but not limited to safety, availability of facilities, budget, and transportation access.

The term “prompt sentence” refers to a machine-processable text sequence, including natural language and optionally structured representations, that is provided as input to a generative AI model to induce the model to generate a desired output.

The term “machine-readable structured description” refers to a representation of data in a format such as a list, table, or structured text (for example, a JSON-like format) that can be deterministically parsed and interpreted by a computing device or a generative AI model.

The term “generative AI model” refers to a trained artificial intelligence model that generates output data, such as ranked lists and natural language explanations, in response to input data including a prompt sentence and associated structured information.

The term “prediction result data” refers to output data produced by the generative AI model, the data including, for each of one or more geographic units, at least a region identifier, a rank or score, and an explanatory reason.

The term “proposal result data” refers to data generated by associating prediction result data with feature data, the data including, for each recommended geographic unit, at least a safety index, an aggregated number of commercial facilities, and an explanatory reason.

The term “user interface” refers to any hardware and software components that present information to a user and receive input from the user, including graphical displays, input controls, and communication mechanisms between a client device and a server.

The term “client device” refers to any user-operated computing apparatus, such as a terminal, mobile device, or workstation, that interacts with the server via a communication network to send user input and receive proposal result data.

The term “communication network” refers to any wired or wireless data communication infrastructure, including local and wide-area networks, that enables data exchange between the server, external information sources, and client devices.

In one embodiment, a server, a terminal, and a communication network cooperate to implement the claimed system. The server includes at least one hardware processor, a main memory, a non-volatile storage device, and a network interface. The server executes server-side software implemented, for example, using an operating system such as a general-purpose server operating system, an application framework such as a web application framework, a data processing library such as a table-oriented data processing library, and a machine learning framework such as a neural-network framework. The terminal includes a processor, a display, an input device such as a touchscreen, and a communication module capable of establishing an encrypted communication session with the server. The user operates the terminal to provide residential conditions and receives proposal result data from the server.

The server stores in the non-volatile storage device one or more program modules, including a user-interface communication module, an external-data acquisition module, a feature-generation module, a prompt-generation module, a generative-AI interface module, and a result-synthesis module. The server loads these modules into main memory and executes them on the processor. The processor executes machine instructions to perform concrete operations on specific data structures; the operations include, for example, filtering, grouping, normalization, vector construction, and neural network inference. The server thereby improves utilization of CPU cache, main memory bandwidth, and network bandwidth by transforming heterogeneous external data into compact, structured feature vectors tailored for a generative AI model.

The terminal runs a client application implemented, for example, using a mobile application framework or a cross-platform framework. The terminal displays, on the display, graphical components such as text fields, sliders, and selection controls through which the user specifies residential conditions. The user inputs free-text requirements such as “I want a very safe area with many new cafes near the station in a specific metropolitan area,” and adjusts sliders or selection controls indicating importance of safety, importance of commercial facilities, maximum acceptable rent, and other evaluation items. The terminal converts these user inputs into a structured representation held in an internal data structure, and the terminal transmits this structured representation to the server over the communication network using a secure protocol.

The server receives the structured data from the terminal and interprets it as user preference data. The server stores the user preference data in a storage structure such as a relational table or a key-value store entry. The server represents each user's preferences by a record containing fields for free-text description, numeric parameters (for example, maximum rent), and weight information for evaluation items (for example, a floating-point weight for safety and a floating-point weight for availability of new commercial facilities). The server validates that each field conforms to a predetermined schema, which allows downstream modules to assume consistent data types and ranges. This structured representation is more expressive than conventional coarse-grained category selections and allows the server to apply precise, non-linear weighting of features during the subsequent computations.

The server acquires raw region-related data from multiple external information sources. The server identifies, from the user preference data, the relevant geographic scope (for example, a set of administrative districts or a set of stations) and the relevant attributes (for example, safety and commercial availability). The server uses the network interface to send authenticated requests to external application programming interfaces exposed by public data providers and commercial data providers. The server receives crime occurrence information as structured records including, for example, incident type, time, geographic code, and severity. The server receives commercial facility information as structured records including, for example, facility type, location coordinates, opening date, and rating. The server stores the raw region-related data in memory-resident tables or in an intermediate database table, using a schema that associates each record with a geographic key.

The server transforms the raw region-related data into region-based feature data. The server groups crime occurrence records by geographic key and by time window, counts incidents, and, where available, links population or household counts from a demographic dataset. The server calculates a crime rate for each geographic unit by dividing an incident count by a population measure and then applies a normalization function such as min-max normalization or z-score scaling to compute a safety index for that geographic unit. The server groups commercial facility records by geographic key, filters facilities by opening date to include only those opened within a predetermined period, and counts such facilities to obtain an aggregated number of commercial facilities for each geographic unit. The server constructs feature data by joining the safety index and the aggregated facility count for each geographic unit into a compact record. The server may also compute additional features such as normalized rent index, distance to a transport hub, or density of particular categories of facilities.

The server generates feature vectors for use by the generative AI model. The server reads the weight information from the user preference data and combines it with the feature data for each geographic unit. The server calculates, for each geographic unit, a weighted composite value by applying a weighted sum or another predetermined aggregation function to selected features such as safety index and aggregated facility count. The server constructs a feature vector that includes the safety index, aggregated facility count, additional attributes, and the weighted composite value. The feature vector is stored in a machine-readable structure such as an ordered list of numeric values with an associated schema defining the meaning of each position. This step compresses a large body of raw external data into a concise, computation-ready representation that can be rapidly consumed by the generative AI model.

The server generates a prompt sentence for the generative AI model. The server includes in the prompt sentence (i) the user's free-text description, (ii) the explicit weight values representing the importance of each evaluation item, and (iii) a machine-readable structured description of candidate regions and their feature vectors. The server additionally embeds explicit instructions that specify the desired output format and reasoning requirements. For example, the server may generate a prompt sentence including the following text:

“You are an assistant that recommends residential areas.

The user is looking for a place to live with the following preferences:
Free-text requirement: ‘I want a very safe area with many new cafes near the station.’
Importance weights: safety=0.9, new_cafes=0.7.

Below is a list of candidate areas with their safety scores (0-100, higher is safer), the number of new cafes opened in the last 12 months, and an initial score based on the user's weights.

Candidate data:
Area: Station A, safety_score: 92, new_cafe_count: 15, pre_ai_score: 0.88
Area: Station B, safety_score: 85, new_cafe_count: 25, pre_ai_score: 0.90
Area: Station C, safety_score: 78, new_cafe_count: 30, pre_ai_score: 0.82

Based on the user's preferences, use the data above to:
1) Rank the areas from best to worst for the user.
2) For each area, output a brief reason that explicitly references the safety score and the new_cafe_count.
3) Return the result in a machine-readable format that can be parsed as records with fields: area, rank, reason.”

The server concatenates such instructions and structured descriptions into a single prompt sentence and provides it as input to the generative AI model. By embedding numerical feature values and explicit formatting requirements into the prompt sentence, the server constrains the model's behavior and avoids non-deterministic, unstructured outputs that are difficult to parse.

The server uses a generative AI model implemented, for example, as a transformer-based neural network. The generative AI model has a plurality of transformer layers, each including multi-head self-attention mechanisms and feed-forward sublayers. The model is pre-trained on a large corpus of text data and further fine-tuned on domain-specific data related to recommendations and numeric reasoning. The server may host the model locally using a machine learning framework, executing inference on one or more graphics processing units, or may access a remote inference service through an application programming interface. The server provides the prompt sentence as tokenized text input to the model. The model computes contextual embeddings for each token and generates output tokens based on learned parameters representing attention weights and layer weights.

The server or a training environment trains the generative AI model using supervised fine-tuning. During training, the model receives input prompt sentences paired with target output structures specifying correct rankings of regions and corresponding reasons. The training process defines a loss function such as a cross-entropy loss between generated tokens and target tokens. The system applies gradient-based optimization such as stochastic gradient descent or an adaptive variant to update layer weights and attention parameters. The training pipeline may include data augmentation (for example, varying user preference descriptions and feature values within realistic bounds) to increase model robustness. This structured training process yields a model that is specifically optimized to interpret region-based feature vectors and weight information embedded in the prompt sentence, and to output rankings and reasons that are closely aligned with the underlying numeric data.

The server executes the generative-AI interface module to perform inference. The server passes the prompt sentence to the generative AI model and receives generated text as output. Because the prompt sentence instructs the model to output machine-readable records and to refer explicitly to numeric fields, the generated output can be parsed by the server using deterministic rules. The server thus avoids reliance on brittle pattern-matching or heuristic parsing that would be required if the model output were unconstrained free text. The server parses the output into prediction result data, which includes, for each recommended region, an identifier, a rank, and an explanatory reason that refers to specific feature values.

The server executes the result-synthesis module to associate the prediction result data with the region-based feature data. The server performs a join operation matching region identifiers in the prediction result data with corresponding feature vectors. The server forms proposal result data that, for each recommended region, includes at least the safety index, the aggregated number of commercial facilities, the weighted composite value, and the explanatory reason generated by the model. The server may sort the proposal result data by rank and may compute additional indicators such as normalized ranking scores. This representation is compact and suitable for transmission over the network and for display on the terminal.

The terminal receives the proposal result data through the network interface. The terminal parses the proposal result data into internal objects and displays a ranked list of regions on the display. The terminal presents, for each region, numerical indicators such as safety score and number of new cafes, along with the explanatory reason. The user views the displayed information and may select a region to obtain further detail, such as a breakdown of crime categories or a map view showing the locations of commercial facilities. The user may adjust preferences and request updated recommendations, and the terminal sends the updated structured data to the server, which reuses cached feature data where appropriate and regenerates new feature vectors and prompt sentences accordingly. Because feature vectors and indexes are reused when possible, the system reduces redundant external data acquisition and decreases network traffic and server processing time.

The described configuration yields technical effects beyond mere automation of human decision-making. The server reconfigures how it stores and processes external data by transforming raw region-related data into normalized feature vectors that are explicitly aligned with user weight information. This design reduces memory footprint and enables efficient reuse of precomputed indices across multiple recommendation sessions. The creation of machine-readable prompt sentences with embedded feature vectors and explicit output-format instructions improves the determinism of generative AI outputs and eliminates costly ad hoc post-processing. The overall pipeline reduces latency by limiting the volume of data transmitted to the generative AI model and by avoiding repeated computation of identical transformations, thereby improving throughput for a high number of concurrent users.

The system further improves accuracy and robustness of region ranking. Because the generative AI model receives structured feature vectors that encode normalized safety indices and facility counts, and because the model has been fine-tuned on training data where correct rankings are conditioned on such numeric features, the model can perform multi-criteria trade-off decisions in a way that is not feasible with simple rule-based weighting alone. The server's use of explicit weight information, embedded both in feature vector computation and in the prompt sentence, allows the model to adapt its reasoning dynamically to each user's preferences. This produces more precise and consistent rankings, reducing the error rate when compared with conventional systems that either rely on static heuristic scores or provide the AI model with only unstructured descriptive text.

In one variation, the server implements further optimization techniques such as caching of feature vectors for specific geographic scopes, incremental updates when new crime or facility data is received, and batching of multiple user requests for joint inference. These techniques further reduce redundant computations and network traffic. In another variation, the server adds additional feature dimensions such as temporal trends in crime data, saturation of specific facility types, or user behavioral history, and the generative AI model is fine-tuned to interpret these extended feature vectors. In yet another variation, the server adapts the neural network architecture, for example by adding specialized input embeddings for structured numeric features or by using a hybrid model that combines a gradient-boosting tree for numeric ranking with a transformer-based model for generating natural language explanations. In all such variations, the core concept remains that the server constructs structured, machine-readable representations of region features and user preferences and uses these representations to drive a generative AI model in a constrained, technically optimized manner.

The system thus provides an implementation form in which the server, terminal, and generative AI model cooperate through specific data structures, algorithms, and processing sequences to improve computer functionality. The server improves internal data management by normalizing and aggregating heterogeneous data into feature vectors, improves computational efficiency by reusing computed indices and minimizing redundant external calls, improves communication efficiency by transmitting compact structured representations and deterministic outputs, and improves inference quality by using a generative AI model that has been trained and prompted to operate on these structured representations.

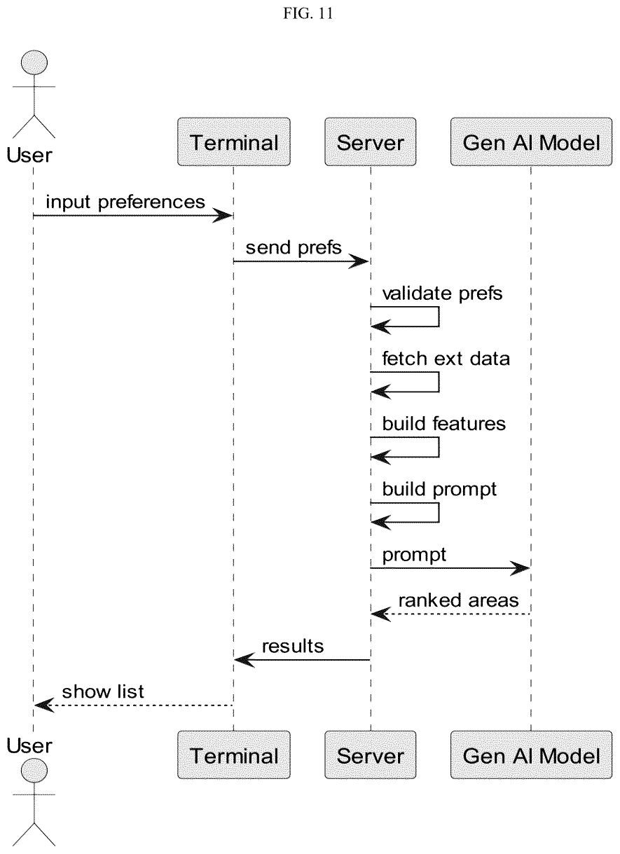

The following describes the processing flow using FIG. 11.

### Step 1

The terminal displays a user interface that includes input fields, sliders, and selection controls for specifying residential conditions. The input of this step is an initial screen state with no user preferences entered. The output of this step is a visible interface that allows the user to enter free-text requirements, numerical constraints (for example, maximum rent), and importance weights for evaluation items such as safety and number of new cafes. The terminal renders these controls using a graphical framework and prepares internal variables to store the values that the user will input.

### Step 2

The user operates the terminal to enter residential conditions. The input of this step is the interactive user interface displayed on the terminal. The output of this step is a set of user-provided values, including at least one free-text description of desired residential conditions, one or more numeric parameters, and one or more importance weights. The user types sentences such as “I want a very safe area with many new cafes near the station” into a text field and adjusts sliders to values such as safety importance=0.9 and new cafes importance=0.7.

### Step 3

The terminal converts the user inputs into structured data. The input of this step is the raw user input captured from the interface components (text fields, sliders, and selectors). The terminal performs data formatting and validation, such as trimming whitespace from text, converting slider positions to floating-point numbers, and assigning default values for omitted fields. The output of this step is a structured record, for example a key-value mapping, that includes fields for free-text requirement, numerical parameters, and weight information for each evaluation item. The terminal stores this structured record in memory and prepares it for transmission.

### Step 4

The terminal transmits the structured user preference data to the server. The input of this step is the structured record generated in Step 3. The terminal encapsulates the record in a request message, establishes an encrypted connection over a communication network, and sends the message to a designated server endpoint. The output of this step is an outbound network request that carries the structured user preference data to the server.

### Step 5

The server receives and validates the structured user preference data. The input of this step is the network request containing the structured record. The server parses the message, checks that required fields are present, verifies that numeric values lie within allowed ranges, and confirms that textual fields are within predefined length limits. The server may normalize certain values, such as clamping weights between 0.0 and 1.0. The output of this step is a validated user preference object stored in server memory and optionally persisted in a data store for logging and later analysis.

### Step 6

The server determines a geographic scope and data acquisition parameters based on the validated user preferences. The input of this step is the user preference object produced in Step 5. The server analyzes fields such as preferred city, maximum commute time, and station-related text to select a set of candidate geographic units (for example, districts or stations). The server generates a list of geographic identifiers and a set of query parameters including time windows and facility categories. The output of this step is a data acquisition plan that specifies which external information sources to contact and what parameters to use for each request.

### Step 7

The server acquires raw region-related data from external information sources. The input of this step is the data acquisition plan generated in Step 6. The server sends network requests to external services that supply crime occurrence information and commercial facility information, using the geographic identifiers and time windows as query parameters. The server receives responses containing records of crime incidents and facility listings. The output of this step is a collection of raw data tables or lists in memory, each record associated with a geographic identifier and including fields such as incident type, timestamp, facility type, and opening date.

### Step 8

The server cleanses and normalizes the raw region-related data. The input of this step is the raw data collection from Step 7. The server removes records with missing essential fields, converts date strings into internal time representations, and standardizes geographic identifiers across different data sources. The server performs deduplication where multiple records describe the same entity. The output of this step is a set of normalized data structures in which each record has consistent formatting and can be associated reliably with a geographic unit.

### Step 9

The server computes a safety index for each geographic unit. The input of this step is the normalized crime occurrence data and, if available, population or household counts associated with each geographic identifier. The server groups crime records by geographic unit and by predetermined time window, counts incidents, and divides the counts by population measures to obtain crime rates. The server then applies a mathematical transformation such as min-max normalization or z-score scaling to convert the crime rates into safety indices on a bounded numeric scale. The output of this step is a mapping from geographic identifiers to safety indices.

### Step 10

The server computes an aggregated number of commercial facilities for each geographic unit. The input of this step is the normalized commercial facility data from Step 8. The server filters facilities to include only those opened within a predetermined period by comparing opening dates with a reference date. The server groups the filtered facilities by geographic identifier and counts the number of facilities per group. The output of this step is a mapping from geographic identifiers to aggregated counts of commercial facilities that satisfy the recency criterion.

### Step 11

The server generates region-based feature data by integrating computed indices. The input of this step is the safety index mapping from Step 9 and the aggregated facility count mapping from Step 10. The server joins these mappings on the geographic identifiers to form a record for each geographic unit that includes at least a safety index and an aggregated facility count. The server may also add additional calculated fields, such as normalized rent indices or distances to transport hubs, if such data is available. The output of this step is a feature data table in which each row corresponds to one geographic unit and each column corresponds to a specific feature.

### Step 12

The server constructs feature vectors and calculates weighted composite values. The input of this step is the feature data table from Step 11 and the weight information contained in the user preference object from Step 5. The server, for each geographic unit, multiplies each feature value by the corresponding weight and sums or otherwise aggregates the products to compute a weighted composite value that reflects the user's relative importance of the features. The server then constructs a feature vector containing the original feature values and the weighted composite value in a predetermined order. The output of this step is a collection of feature vectors, each associated with a geographic identifier and ready for use in subsequent processing.

### Step 13

The server selects candidate regions and prepares data for prompting. The input of this step is the collection of feature vectors generated in Step 12. The server may filter out regions that do not meet hard constraints from the user preferences, such as regions whose average rent exceeds the user's maximum rent. The server may sort or pre-rank the remaining regions by the weighted composite value and select a subset of top candidates to reduce prompt length and inference cost. The output of this step is a subset of candidate regions along with their corresponding feature vectors and identifiers.

### Step 14

The server generates a prompt sentence for a generative AI model. The input of this step is the candidate region set from Step 13 and the user preference object from Step 5. The server combines the free-text requirement, numeric weight values, and the feature values for each candidate region into a single text sequence. The server includes explicit instructions to the model regarding ranking and explanation format. The output of this step is a prompt sentence, for example:

“You are an assistant that recommends residential areas.

The user is looking for a place to live with the following preferences:
Free-text requirement: ‘I want a very safe area with many new cafes near the station.’
Importance weights: safety=0.9, new_cafes=0.7.

Below is a list of candidate areas with their safety scores (0-100, higher is safer), the number of new cafes opened in the last 12 months, and an initial score based on the user's weights.

Candidate data:
Area: Station A, safety_score: 92, new_cafe_count: 15, pre_ai_score: 0.88
Area: Station B, safety_score: 85, new_cafe_count: 25, pre_ai_score: 0.90
Area: Station C, safety_score: 78, new_cafe_count: 30, pre_ai_score: 0.82

Based on the user's preferences, use the data above to:
1) Rank the areas from best to worst for the user.
2) For each area, output a brief reason that explicitly references the safety score and the new_cafe_count.
3) Return the result in a machine-readable format that can be parsed as records with fields: area, rank, reason.”

### Step 15

The server inputs the prompt sentence to the generative AI model and obtains prediction result data. The input of this step is the prompt sentence created in Step 14. The server sends the prompt to a generative AI model, for example a transformer-based neural network, using an application programming interface or a local inference module. The model processes the input tokens and generates output tokens representing a machine-readable description of recommended regions, including ranks and reasons. The output of this step is a text response from the generative AI model that can be parsed into distinct records.

### Step 16

The server parses the output of the generative AI model into structured prediction result data. The input of this step is the text response from Step 15. The server applies deterministic parsing rules to identify the area name, rank, and explanatory reason for each recommended region. The server validates that ranks are unique and that all mentioned areas correspond to the candidate regions or can be matched unambiguously. The output of this step is a structured prediction result object, which includes for each recommended region a region identifier, a rank value, and an associated reason string.

### Step 17

The server synthesizes proposal result data by associating prediction results with feature data. The input of this step is the structured prediction result object from Step 16 and the feature data table from Step 11. The server joins the prediction records with the corresponding feature records using region identifiers as keys. The server constructs, for each recommended region, a record that includes at least the safety index, the aggregated number of commercial facilities, the weighted composite value, and the explanatory reason. The output of this step is proposal result data formatted for transmission to the terminal.

### Step 18

The server transmits the proposal result data to the terminal. The input of this step is the proposal result data generated in Step 17. The server serializes the data into a transmission format and sends it over the communication network to the terminal using a response message to the original request. The output of this step is a network response containing all recommended regions and their associated indicators and explanations.

### Step 19

The terminal receives and parses the proposal result data. The input of this step is the network response from Step 18. The terminal decodes the response, extracts region records, and constructs internal objects representing each recommended region. The terminal may sort the regions by rank if not already sorted. The output of this step is a set of structured region recommendation objects stored in terminal memory.

### Step 20

The terminal displays the recommended regions and allows user interaction. The input of this step is the structured region recommendation objects from Step 19. The terminal renders a list or grid on the display, showing for each region at least the region name, safety score, number of new cafes, and the explanatory reason. The user views these results and may select an item to see additional details such as maps or historical trends. The output of this step is a visual presentation of the proposal result data and updated interface state that reflects any user selections.

### Step 21

The user reviews the recommendations and optionally refines the preferences. The input of this step is the displayed recommendation interface from Step 20. The user may decide that safety should be even more important or that maximum rent should be lowered and edits the corresponding controls on the terminal. The output of this step is a new set of user inputs that can be processed by repeating Steps 3 through 20, allowing iterative refinement of recommendations based on updated preferences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems that propose residential areas or business facility locations typically rely on manually designed scoring rules, coarse-grained statistical data, or static user profiles. Such systems often treat heterogeneous external data sources, such as public databases, social media content, review sites, and local information sources, in a fragmented manner and do not effectively integrate these sources into a unified feature representation suitable for advanced machine learning models. As a result, the systems tend to generate generic recommendations that do not adequately reflect nuanced user preferences, such as combinations of safety, density and recency of business facilities, merchandise assortment and price level of nearby retail outlets, and characteristics of a target customer group.

Moreover, existing computer architectures for recommendation frequently process user input and external data in separate pipelines, without dynamically tailoring the model input to the user's current intent. In particular, many systems pass raw or minimally preprocessed data to a predictive model without generating a structured, model-specific prompt sentence that encodes constraint conditions and environmental attributes in a way that maximizes the discriminative power of the model. This leads to suboptimal utilization of computational resources and limits the improvement of prediction accuracy and ranking quality for candidate areas or business facility locations.

In addition, when multiple information sources provide conflicting or inconsistent data, conventional systems often either discard unreliable data or apply simplistic resolution rules, which may degrade the quality of the integrated dataset. Such approaches do not systematically incorporate reliability or weighting into the data integration process, thereby failing to fully exploit available information. Consequently, the internal feature data supplied to the model may be noisy or biased, which in turn reduces the effectiveness of subsequent generative AI-based analysis.

Furthermore, known systems generally do not tightly couple natural language processing of user input with the generation of structured internal attributes that are explicitly aligned with the feature vectors of candidate areas. This lack of alignment hampers the ability of the computer system to interpret the user's intent at a fine-grained level and to adjust the generative model input accordingly. As a result, the system cannot consistently provide high-quality, context-aware ranking of candidate locations based on detailed user constraints and complex environmental conditions.

Accordingly, there is a need for an improved computer-implemented system and method that: (i) acquires environment-related data from multiple heterogeneous information sources and integrates the data into normalized, conflict-resolved feature representations; (ii) automatically analyzes user input by natural language processing to generate internal attribute information representing constraint conditions; (iii) constructs a model-specific prompt sentence and structured feature tensors that jointly encode user preferences and environment-related attributes; and (iv) inputs these representations into a generative AI model to obtain accurate prediction results and explanation information. Such a system should improve the functioning of the computer itself by optimizing data processing pipelines, enhancing model input formulation, and enabling more efficient and effective utilization of computational resources for recommendation tasks.

The specific processing by the specific processing unit 290 of the data processing device 12 in Application Example 1 is realized by the following means.

The present invention provides a server comprising a processor configured to receive, from a client device, input information from a user including preference conditions regarding a living environment or a business facility location and conditions regarding a target customer group; to analyze, by natural language processing, the input information to extract internal attribute information representing constraint conditions relating to safety, business facility density, retail outlet characteristics, and price level; to extract reference items corresponding to the preference conditions and the target customer group from the input information and to generate inquiry information based on the reference items; to acquire, via a communication network from a plurality of information sources, environment-related data including regional safety information, new business facility information, retail outlet information, and price level information on the basis of the inquiry information; to associate and integrate the environment-related data using candidate area identification information or area codes and to perform correction processing based on a weighted average or a reliability level when conflicting data exist; to perform normalization processing, feature extraction processing, and attribute assignment processing on the integrated environment-related data and to generate integrated feature data for each candidate area; to construct, based on the internal attribute information and the integrated feature data, a model-specific prompt sentence for a generative AI model that encodes the user's constraint conditions and environmental attributes; to input the prompt sentence and the integrated feature data into the generative AI model and cause the generative AI model to execute computational processing including matrix operations and nonlinear transformations to obtain a prediction result indicating a suitability level for each candidate area or each candidate business facility location; to rank the candidate areas or the candidate business facility locations based on the prediction result; to generate, for each candidate, explanation information including a safety index, a concentration level of new business facilities, a merchandise assortment of retail outlets, and a price range; and to output, to a user display screen of the client device, a proposal result including the explanation information. This enables an improved computer-implemented recommendation process in which heterogeneous environment-related data are automatically normalized and conflict-resolved, user intent is converted into structured internal attributes and a model-specific prompt sentence, and a generative AI model is supplied with optimized feature representations, thereby enhancing prediction accuracy, ranking quality, and computational efficiency in proposing suitable residential areas and business facility locations.

The term “processor” refers to a hardware-based information processing unit, such as a central processing unit or an execution core, configured to execute program instructions and perform arithmetic, logical, and data-handling operations for implementing the functions of the system.

The term “user” refers to a human operator who interacts with the system via a client device, provides input information including preference conditions and target customer group conditions, and receives proposal results.

The term “client device” refers to an information processing apparatus, such as a terminal device or computing device, that communicates with the server via a communication network and provides a user interface for inputting information and displaying proposal results.

The term “preference conditions” refers to constraints, requirements, or desired attributes specified by the user regarding a living environment or a business facility location, including but not limited to safety level, business facility density, retail outlet characteristics, and price level.

The term “target customer group” refers to a set of potential end customers characterized by demographic or behavioral attributes, such as age range, gender, lifestyle, or purchasing behavior, for which a business facility is intended.

The term “input information” refers to data received from the user via the client device, including natural language text, selection items, and parameter values, that describe the preference conditions and the conditions of the target customer group.

The term “reference items” refers to internal criteria, attributes, or evaluation aspects derived from the input information, which are used by the processor to form search conditions or inquiry information for acquiring environment-related data.

The term “inquiry information” refers to structured query data generated based on the reference items and used to obtain environment-related data from a plurality of information sources via a communication network.

The term “communication network” refers to a wired or wireless data communication infrastructure, including the Internet or a local area network, that enables data exchange between the server and external information sources or client devices.

The term “information sources” refers to external data-providing systems, services, or repositories, including but not limited to public databases, online platforms, review services, and local information services, from which environment-related data are acquired.

The term “environment-related data” refers to data describing attributes of geographic areas or locations, including regional safety information, new business facility information, retail outlet information, and price level information.

The term “regional safety information” refers to data indicating a level of safety or risk in a geographic area, such as crime rates, incident statistics, or safety indexes.

The term “new business facility information” refers to data describing newly established or recently opened commercial entities or service facilities in a geographic area, including facility type, opening date, and location.

The term “retail outlet information” refers to data describing consumer-facing sales establishments in a geographic area, including merchandise categories, assortment breadth, customer ratings, and store attributes.

The term “price level information” refers to data indicating representative or average prices for goods or services in a geographic area, including price categories, typical spending ranges, or relative pricing indices.

The term “candidate area” refers to a geographic region, zone, or district considered by the system as a possible recommendation target for a living environment or a business facility location.

The term “candidate business facility location” refers to a specific geographic position, area, or site evaluated by the system as a possible location for establishing or operating a business facility.

The term “normalization processing” refers to a data transformation operation that scales or adjusts values of environment-related data into a standardized range or distribution format suitable for subsequent analysis or model input.

The term “feature extraction processing” refers to a computational procedure that derives numerical or categorical feature values from raw environment-related data, including operations such as encoding, aggregation, or dimensionality reduction.

The term “attribute assignment processing” refers to a processing operation that associates environment-related data with predefined attribute labels or fields, such as safety index, facility density, or price category, for each candidate area.

The term “integrated feature data” refers to a structured set of feature values, obtained by integrating and processing environment-related data from a plurality of information sources, representing the characteristics of each candidate area or candidate business facility location.

The term “internal attribute information” refers to structured data representing constraint conditions or preferences extracted from the user's input information by natural language processing, and aligned with feature dimensions used for model input.

The term “constraint conditions” refers to limitations, thresholds, or required ranges applied to attributes such as safety, business facility density, retail outlet characteristics, or price level, derived from user preferences.

The term “natural language processing” refers to a computational technique in which the processor analyzes textual input expressed in a human language to detect semantic content, extract attributes, and convert the text into structured internal representations.

The term “model-specific prompt sentence” refers to a text-based or structured prompt prepared for a generative AI model, which encodes internal attribute information and integrated feature data in a form optimized for processing by the model.

The term “prompt sentence” refers to a sequence of text or token data that represents a query, instruction, or description provided as an input condition to a generative AI model, guiding the model's prediction or generation.

The term “generative AI model” refers to a machine learning model, such as a neural network implemented on a computing platform, that processes prompt sentences and feature data to generate prediction results, rankings, or textual outputs.

The term “generative information processing model” refers to a type of generative AI model that is configured to process inputs including prompt sentences and feature data and to output prediction results or generated information based on learned parameters.

The term “matrix operations” refers to computational operations on two-dimensional arrays of numerical values, including multiplication, addition, and transformation of matrices, as typically performed within neural network computations.

The term “nonlinear transformations” refers to activation operations or functions applied to numerical data within a model, such as rectified linear units, sigmoidal functions, or other nonlinear mappings, used to introduce nonlinearity into the computation.

The term “prediction result” refers to output data produced by the generative AI model indicating suitability levels, scores, rankings, or classifications for candidate areas or candidate business facility locations.

The term “suitability level” refers to a quantitative or qualitative measure indicating how well a candidate area or candidate business facility location matches the user's preference conditions and constraint conditions.

The term “ranking” refers to an ordered arrangement of candidate areas or candidate business facility locations based on their suitability levels or other evaluation criteria.

The term “safety index” refers to a derived numerical or categorical score indicating a relative safety status of a candidate area, based on regional safety information.

The term “concentration level of new business facilities” refers to a measure, such as a density value or index, indicating how many new business facilities are present in or near a candidate area.

The term “merchandise assortment of retail outlets” refers to a characterization of the variety, breadth, or composition of goods provided by retail outlets in a candidate area.

The term “price range” refers to an indication of the typical or average cost level of goods or services in a candidate area, such as low, medium, or high pricing categories.

The term “explanation information” refers to descriptive data generated for each candidate area or candidate business facility location, including indicators such as safety index, concentration level of new business facilities, merchandise assortment, and price range, that provide reasons or context for the recommendation.

The term “proposal result” refers to a set of recommended candidate areas or candidate business facility locations, together with associated prediction results and explanation information, output to the user.

The term “user display screen” refers to a visual output interface of the client device, such as a display panel or graphical user interface, on which the proposal result and related information are presented to the user.

In one embodiment, a server executes a software program implemented as a networked application running on a general-purpose computing platform. The server includes at least one central processing unit, a volatile memory, a non-volatile storage device, and a network interface. The server executes an operating system and an application stack that includes a web application framework, a web scraping library, a browser automation library, a numerical computation framework, and a machine learning framework. For example, the server uses a framework such as a lightweight web server framework to implement an HTTP-based application programming interface, a structured document parser to process markup data, a browser automation engine to control a headless browser, and a tensor computation framework to execute a generative AI model.

The server stores in the non-volatile storage device a trained generative AI model. The generative AI model is, in one embodiment, a neural network architecture having an encoder part and a decoder or scoring part. The encoder part includes an embedding layer that maps words or tokens in a prompt sentence into dense numerical vectors, one or more stacked recurrent or transformer layers that process token sequences by attention mechanisms and matrix multiplications, and optional pooling layers that compress a sequence representation into a fixed-length context vector. The decoder or scoring part includes fully connected layers that combine the context vector derived from the prompt sentence with a feature vector representing a candidate area or candidate business facility location. The decoder outputs one or more numerical suitability scores. The server stores model parameters, including weight matrices, bias vectors, and hyperparameters such as learning rate, number of layers, and embedding dimension, in the storage device and loads them into memory for execution.

The terminal operates as a client device that communicates with the server through a communication network. The terminal includes a processor, a display, an input interface such as a touch panel or keyboard, and a communication interface. The terminal executes a web browser or a native application that issues HTTP requests to the server and renders HTML or structured response data as interactive screens. The terminal displays input fields for user preferences and target customer group conditions. The user operates the terminal and provides free-text input in natural language and optionally selects additional parameters through graphical user interface controls such as check boxes, radio buttons, or sliders.

The server receives the input information from the terminal through the network interface. The input information includes one or more natural language sentences and structured parameters describing preference conditions, such as desired safety level, density of newly opened facilities, characteristics of nearby retail outlets, and acceptable price level, as well as attributes of a target customer group such as age range and lifestyle. Example prompt sentences input by the user via the terminal include:

“I want to open a fashion store for women in their 20s in a safe area with many new cafes.”

“Recommend safe urban areas with many new fashion stores and cafes that are popular among women in their 20s.”

“I am looking for a quiet residential area with good safety, moderate rent, and convenient access to supermarkets.”

The server stores the received input information in a data structure in memory, for example, as a hierarchical object comprising text fields and scalar fields. The server applies natural language processing to the text fields using a text pre-processing module. The server converts characters to a normalized form, removes or unifies punctuation, and applies tokenization rules that segment sentences into tokens. The server uses preconfigured vocabularies and token dictionaries that map frequent words and phrases such as “safe area,” “new cafes,” “women in their 20s,” “moderate rent,” and “quiet residential area” to internal attribute labels and constraint types.

The server generates internal attribute information by mapping the tokens and phrases to structured attributes, such as a safety constraint, a new-facility density constraint, a retail assortment constraint, a price range constraint, and a target demographic constraint. The server associates each attribute with a desired range or threshold. For example, the server assigns a lower maximum value for crime-rate features when a high safety preference is detected, sets a minimum density value for new facilities when “many new cafes” is detected, and assigns an age range category when “women in their 20s” is detected. The server stores this internal attribute information as key-value pairs in memory.

The server generates inquiry information based on the internal attribute information. The server constructs query parameters that specify geographic scope, facility types of interest, time ranges for newly opened facilities, and categories of retail establishments. The server builds uniform resource locator strings and request payloads used to acquire environment-related data from external information sources. Environment-related data include regional safety statistics from public databases, newly registered business entries from administrative or commercial registries, review content and ratings from review services, and price indicators and assortment tags from local information services.

The server uses the browser automation engine to open web pages corresponding to the constructed uniform resource locators and to execute client-side scripts to obtain dynamically generated content. The server obtains page source data from the headless browser and applies the structured document parser to the data. The server traverses the document object model and applies extraction rules to locate specific table cells, list items, tags, and attributes that contain region names, facility types, dates, ratings, price tags, and other environment-related information. The server stores extracted elements into temporary data structures, such as arrays of records, in memory.

The server merges environment-related data from multiple information sources by associating entries that have the same or related area identifiers. The server uses region codes, normalized address strings, or geographic coordinates to associate data across sources. When conflicting values appear for a particular indicator, such as two different safety index values for the same region, the server applies a conflict-resolution algorithm. In one embodiment, the server maintains reliability scores for each information source and computes a weighted average of conflicting numerical values according to the reliability scores. In another embodiment, the server assigns priority to selected sources for specific indicators and discards lower-priority values. The server writes the resolved values to an integrated environment dataset.

The server transforms the integrated environment dataset into integrated feature data for each candidate area or candidate business facility location. The server applies normalization procedures to numerical values. For example, the server performs min-max scaling or z-score normalization for features such as crime-rate indices, facility density measures, and average price indicators. The server encodes categorical attributes such as facility-type categories and district categories using one-hot encoding or learned embedding vectors. The server aggregates textual characteristics, such as review keywords and neighborhood descriptions, into numerical vectors using embedding mechanisms. The server combines all feature dimensions into a feature vector of fixed length for each candidate entity and stores these vectors in a contiguous numerical array to optimize memory access and batch processing.

The server constructs a model-specific prompt sentence that summarizes the user's constraints and links them to the integrated feature domains. The server, for example, generates a text such as:

“Given regions with low crime rate, high density of newly opened cafes and fashion-related facilities, mid-range retail price level, and popularity among women in their 20s, generate a ranked list of candidate areas that match the user's lifestyle preferences and business potential.”

The server encodes this model-specific prompt sentence using the same tokenizer and embedding scheme used in training the generative AI model. The server obtains a sequence of token indices and maps each token to an embedding vector, forming a prompt embedding matrix. The server then prepares a batch of candidate feature vectors representing the integrated feature data corresponding to geographic areas or business facility sites under consideration.

The server feeds the prompt embedding matrix and the candidate feature vectors to the generative AI model. In one embodiment, the encoder component of the model applies attention layers, in which the server performs matrix multiplications between query, key, and value matrices derived from the embeddings. The server applies non-linear activation functions, such as rectified linear unit or other non-linearities, to generate context representations for the prompt. The server then concatenates or otherwise combines the context representation of the prompt with the feature vector for each candidate and passes the combined representation through one or more fully connected layers. The server computes output scores through final activation functions, such as sigmoid or softmax, that normalize or map raw outputs into suitability scores.

The server executes the generative AI model on the tensor computation framework, which optimizes matrix and vector operations on the available hardware. Depending on the configuration, the server uses central processing units, graphical processing units, or other accelerators to perform the tensor computations. By structuring the input data into batched tensors and by encoding the user prompts and environment-related features in a joint representation, the server reduces redundant computations, increases throughput, and enhances overall processing speed compared to naive, candidate-by-candidate evaluation.

The server receives from the generative AI model, for each candidate area or location, a suitability score or set of scores. The server ranks the candidates in descending order of suitability and may apply additional constraints, such as excluding regions whose normalized safety index falls below a threshold derived from the internal attribute information. The server then generates explanation information for each candidate. The server selects relevant feature values, such as safety index, density of new facilities, typical retail price range, and representation of merchandise assortment, and constructs descriptive sentences. For example, the server may generate explanation text such as:

“This area has a high safety index, a high concentration of newly opened cafes and fashion boutiques, and mid-range retail prices, and is frequently visited by women in their 20s.”

The server composes a proposal result that includes the ranked list of candidates, their suitability scores, and the explanation information. The server serializes this proposal result into a structured response and transmits it to the terminal via the communication network. The terminal receives the proposal result, parses the structured response, and displays the information on the display. The terminal may use charts, tables, or interactive maps to visualize the candidate areas and their attributes. The user views the proposal result on the terminal, compares candidate areas or locations, and may modify the preferences by adjusting the input text or parameters, thereby causing the server to re-execute the described processing with updated constraints.

The server improves computer technology in several ways. By converting user input into internal attribute information aligned with the feature dimensions of the environment-related data, the server reduces ambiguity and avoids ad-hoc manual interpretation. This alignment enables efficient construction of model-specific prompt sentences and structured feature tensors, which results in improved utilization of the generative AI model and reduces computational redundancy. By integrating heterogeneous data sources with conflict resolution based on reliability weights, the server produces higher-quality integrated feature data, which in turn reduces noise and leads to more accurate and stable model predictions. The use of batched tensor operations and shared prompt context further reduces processing time per query and increases throughput, especially when the server handles concurrent users.

The server does not merely automate a conventional manual recommendation process. The server applies a specific, non-conventional combination of natural language processing, weighted data integration, feature normalization, and generative AI-based scoring to achieve technical effects. For example, the server reduces network traffic by generating inquiry information that targets only those sources and attributes that are relevant to the internal attribute information, rather than indiscriminately collecting a broad set of data. The server improves data management by representing integrated feature data in compact, fixed-length vectors that are reused across multiple model evaluations. The server increases prediction accuracy by training the generative AI model with loss functions that measure error between predicted suitability scores and observed outcomes, such as user selection or historical performance of locations, and by updating model parameters through gradient-based optimization algorithms. The server uses learning strategies such as regularization, dropout, or data augmentation for textual descriptions to avoid overfitting and to generalize to unseen areas.

In another embodiment, the server employs different neural network architectures. For example, the server may use a transformer-based encoder for the prompt sentence and a separate multi-layer perceptron for feature vectors, with an attention mechanism that attends from candidate features to prompt context. In a further embodiment, the server uses a convolutional neural network to capture spatial correlations in region features when geographic coordinates or grid-based representations are available. These architectural variations remain within the scope of the same technical framework of combining internal attribute information and environment-related feature vectors under a generative AI model that outputs suitability scores.

In yet another embodiment, the server implements alternative conflict-resolution schemes. The server may employ a probabilistic model that estimates a latent true value for an indicator given multiple noisy observations from different sources, with source reliability parameters learned from historical consistency data. This configuration further improves data quality and directly impacts the performance of the generative AI model by providing less biased feature inputs.

The terminal and the server together form a technical system that controls how data flows from user input to external information sources, into internal feature representations, through a generative AI model, and back to a user interface. By designing this flow with explicit, structured intermediate representations (internal attribute information, inquiry information, integrated feature data, prompt embeddings, and suitability scores), the system provides a repeatable and technically efficient pipeline that can be implemented, tested, and optimized on general-purpose computing hardware. This pipeline goes beyond a high-level business workflow and directly specifies how computer resources are allocated and how data structures are manipulated to achieve improved speed, accuracy, and robustness in recommending living environments and business facility locations.

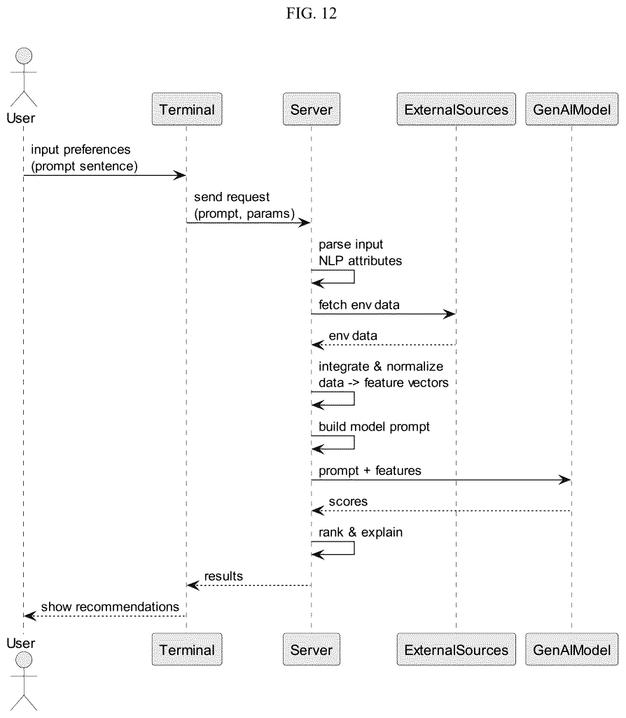

The following describes the processing flow using FIG. 12.

### Step 1

The terminal displays an input screen and collects user preferences.

The terminal renders a user interface including text input fields and selectable options for conditions such as safety level, presence of new business facilities, retail assortment, price range, and target customer group attributes. The user operates the terminal and inputs one or more natural language sentences (for example, a prompt sentence such as “I want to open a fashion store for women in their 20s in a safe area with many new cafes.”) and optionally adjusts sliders or check boxes that represent numeric or categorical constraints.

Input: Raw user interactions (keystrokes, taps, selections) representing preference conditions and target customer group conditions.

Output: Structured input data at the terminal side, including a prompt sentence string and parameter values, packaged into a request payload.

### Step 2

The terminal transmits the structured input data to the server.

The terminal constructs an HTTP request, embeds the prompt sentence and parameter values in a request body (for example, in a JSON or form-encoded format), and sends this request to a predefined endpoint of the server over a communication network. The terminal includes session identifiers and optional metadata such as language or region settings.

Input: Structured input data holding the user's prompt sentence and parameter values.

Output: Network-transmitted request data delivered to the server via the communication network.

### Step 3

The server receives and parses the user input.

The server accepts the HTTP request through a web application framework, reads the request body, and parses it into internal data structures such as dictionaries or objects. The server extracts the prompt sentence text, the numerical and categorical parameters, and any contextual metadata. The server validates the fields, checks required parameters, and stores the parsed content in a working memory area associated with the user session.

Input: Network request data containing the prompt sentence and parameters.

Output: Parsed input object containing normalized fields (prompt string, safety preference, facility density preference, price preference, target demographic attributes, and others).

### Step 4

The server performs natural language preprocessing and attribute extraction.

The server takes the prompt sentence from the parsed input object and applies text normalization (lowercasing, trimming, punctuation handling) and tokenization to segment the sentence into tokens. The server applies a vocabulary-based mapping and rule-based or model-based phrase detection to identify expressions such as “safe area,” “many new cafes,” “women in their 20s,” “quiet residential area,” and “moderate rent.” Using these detections, the server generates internal attribute information representing constraint conditions, including a safety threshold, a new-facility density threshold, a price range category, and a target demographic category.

Input: Prompt sentence text and optional text-type preference fields.

Output: Internal attribute information represented as structured key-value data (for example, safety_level=high, new_facility_density=high, price_range=medium, target_age_group=20s_female).

### Step 5

The server generates inquiry information for external data acquisition.

The server uses the internal attribute information to construct search queries and filter parameters for external information sources. The server selects relevant geographic regions or region categories to investigate and composes uniform resource locator strings and query parameters that request regional safety statistics, newly opened facility lists, retail store data, and price indicators. The server may, for example, convert a “high safety” constraint into a query for regions with crime indices below a threshold and convert “many new cafes” into a minimum count constraint for newly registered cafes in a recent time window.

Input: Internal attribute information (constraint conditions and target demographic attributes).

Output: Inquiry information including search URLs, API query parameters, and source selection metadata.

### Step 6

The server acquires environment-related data from multiple information sources.

The server, based on the inquiry information, sends requests to external data providers or opens web pages using a browser automation engine. The server retrieves page content or response payloads from public databases, local information services, review platforms, and registry sources. The server passes retrieved markup data to a structured document parser and extracts relevant fields such as region identifiers, crime indices, facility types, opening dates, review ratings, and price tags. The server temporarily stores these extracted fields in source-specific intermediate tables or record lists.

Input: Inquiry information specifying external sources and query conditions.

Output: Raw environment-related data from multiple sources, organized as source-specific collections of records.

### Step 7

The server integrates and reconciles environment-related data.

The server associates records from different sources by matching region identifiers, normalized addresses, or area codes, and merges them into unified records for each candidate area or candidate business facility location. When the server detects conflicting values for a particular metric (for example, two different crime index values from different sources for the same region), the server performs conflict resolution. The server may apply a weighted averaging procedure using predefined reliability weights for each source or may select a value based on a reliability ranking. The server writes the reconciled values into an integrated environment dataset, ensuring that each candidate entity has a single consolidated value for each relevant indicator.

Input: Source-specific environment-related data sets containing overlapping and possibly conflicting fields.

Output: Integrated environment dataset with reconciled, unified records per candidate area or location.

### Step 8

The server performs normalization and feature vector construction.

The server transforms the integrated environment dataset into numerical feature vectors suitable for model input. The server applies normalization functions such as min-max scaling or standardization to continuous features (for example, crime indices, facility counts, average prices). The server converts categorical attributes (for example, facility type categories, area types) into encoded vectors using one-hot encoding or learned embeddings. The server processes textual attributes, such as region descriptions or aggregated review keywords, using text embedding functions to obtain numeric vectors. The server concatenates these numeric components to form a fixed-length feature vector for each candidate area or candidate business facility location and stores all vectors in a batched array or tensor structure for efficient processing.

Input: Integrated environment dataset with consolidated indicator values and categorical labels.

Output: Integrated feature data consisting of a batched set of feature vectors representing candidate areas or locations.

### Step 9

The server constructs a model-specific prompt sentence.

The server uses the internal attribute information extracted from the user's input together with summary statistics of the integrated feature data to build a model-specific prompt sentence. The server generates a text that explicitly states numeric or categorical constraints aligned with the feature space, such as “low crime rate,” “high density of newly opened cafes and fashion-related facilities,” “medium retail price level,” and “popular among women in their 20s.” The server combines these statements into a coherent sentence or structured description, for example: “Given regions with low crime rate, high density of newly opened cafes and fashion-related facilities, and mid-range retail price level that are preferred by women in their 20s, generate suitability scores and a ranked list of areas that match the user's preferences.”

Input: Internal attribute information and summary characteristics of the integrated feature data.

Output: Model-specific prompt sentence text prepared for the generative AI model.

### Step 10

The server encodes the model-specific prompt sentence and prepares model input tensors.

The server tokenizes the model-specific prompt sentence using the same tokenizer configuration that was employed during model training. The server maps each token to an embedding vector, thereby constructing a prompt embedding matrix. The server pairs the prompt embedding matrix with the batched feature vectors for candidates, optionally replicating the prompt representation for each candidate or building a joint representation that references all candidates at once. The server arranges these structures into one or more tensors that conform to the input format of the generative AI model.

Input: Model-specific prompt sentence text and integrated feature data (feature vectors).

Output: Encoded prompt embeddings and candidate feature tensors suitable for input to the generative AI model.

### Step 11

The server runs the generative AI model to compute suitability scores.

The server supplies the prompt embeddings and candidate feature tensors to the generative AI model implemented on a tensor computation framework. Within the model, the server executes layers such as embedding layers, attention layers, and fully connected layers by performing matrix multiplications, additions, and non-linear activation operations. The encoder component processes the prompt embeddings to produce a prompt context representation, and the decoder or scoring component combines this context with each candidate's feature vector to compute one or more raw scores. The server then applies output activation functions, such as sigmoid or softmax, to normalize or map the raw scores into suitability levels for the respective candidates.

Input: Prompt embedding matrix and batched candidate feature tensors.

Output: Suitability scores or prediction values for each candidate area or candidate business facility location.

### Step 12

The server ranks candidates and generates explanation information.

The server sorts candidate areas or locations by their suitability scores in descending order. The server optionally filters out candidates that violate hard constraints derived from the internal attribute information, such as regions whose safety index falls below a threshold. For each remaining candidate, the server selects relevant feature values, including safety-related metrics, density of newly opened facilities, typical retail price level, and assortment characteristics. The server then composes explanation sentences that describe why each candidate is recommended, linking the values of these features to the user's constraints and preferences.

Input: Suitability scores per candidate and corresponding feature vectors, along with internal attribute information.

Output: Ranked list of candidates with associated explanation information for each candidate.

### Step 13

The server assembles a proposal result and returns it to the terminal.

The server packages the ranked candidates, their suitability scores, and the explanation texts into a structured response object. The server may enrich the response with identifiers that the terminal can use to display maps or detailed views (for example, region names, area codes, or coordinates). The server transmits this response to the terminal over the communication network using the web application framework.

Input: Ranked candidate list and explanation information.

Output: Serialized proposal result data sent to the terminal.

### Step 14

The terminal renders the proposal result to the user.

The terminal receives the proposal result from the server and parses the structured data into internal objects. The terminal displays the ranked list of candidate areas or locations on the display, along with suitability scores and explanation texts. The terminal may render interactive elements such as clickable entries that reveal detailed attributes, comparison views, or map positions. The user views these outputs and may use the provided information to make decisions about living environments or business facility locations.

Input: Serialized proposal result data from the server.

Output: Visual representation of candidate recommendations and explanations on the terminal display.

### Step 15

The user refines preferences and initiates additional iterations.

The user, after examining the displayed results, may decide to refine the initial preferences.

The user edits the prompt sentence (for example, changing “mid-range retail prices” to “lower retail prices” or “quiet residential area” to “more lively area”) or adjusts controls such as safety level sliders or price range selectors. The terminal collects these revised inputs and triggers a new request to the server, which then repeats Steps 2 through 14 with updated internal attribute information and environment-related data if necessary.

Input: Updated user prompt sentence and modified parameter settings entered on the terminal.

Output: New structured input data sent to the server for reprocessing, enabling refined recommendation results.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional recommendation systems for residential areas primarily rely on coarse, static preference settings directly entered by a user, such as desired rent range, distance to a workplace, or presence of basic facilities. Such systems generally treat user inputs and region information as isolated parameters and generate recommendations through simple rule-based filtering or basic scoring. As a result, these systems often fail to capture complex behavioral patterns of the user, such as actual visiting tendencies, purchasing tendencies, or latent interests that are not explicitly stated. This leads to recommendations that are poorly aligned with the user's true preferences, thereby degrading user satisfaction and wasting computational resources on generating low-value recommendation results.

Furthermore, many existing systems perform data analysis and recommendation logic in separate, loosely coupled modules without a unified architecture for (i) collecting fine-grained behavior history from user terminals, (ii) transforming the raw behavior history into machine-learnable feature data, (iii) estimating user preferences using machine learning techniques, and (iv) tightly integrating these estimated preferences with detailed regional information. This fragmented design results in redundant data processing, inefficient use of storage and network resources, and increased latency in generating updated recommendations when new behavior data or feedback is available.

In addition, while generative AI models are increasingly used to generate natural language explanations, conventional systems typically pass only high-level, unstructured prompts to such models and do not embed structured, machine-derived feature data and suitability scores directly into the prompt sentence. Without explicit, structured data describing behavior features, estimated preferences, region attributes, and region suitability indices, the generative AI model cannot reliably produce explanations that are both accurate and consistent with the underlying computational logic. This leads to explanations that may be vague, inconsistent with the actual scoring and selection process, or difficult to validate, thereby limiting transparency and user trust.

Moreover, existing systems rarely close the loop between user feedback on recommendations and the underlying preference estimation and prompt generation logic. In many cases, explicit user evaluations of recommended regions (for example, “like” or “dislike”) are either ignored or only used in an ad hoc manner, preventing the system from systematically improving the quality of future recommendations. The inability to efficiently incorporate feedback into the machine learning models and the prompt construction pipeline further reduces the adaptability and robustness of the system.

Accordingly, there is a need for an improved computer-implemented technique that (i) systematically collects and preprocesses user behavior history including location and purchase data, (ii) estimates user preferences using machine learning based on behavior feature data, (iii) computes region suitability indices by combining estimated preferences with rich region-related information, (iv) embeds this structured data into prompt sentences for a generative AI model in a controlled and reproducible manner, and (v) iteratively updates user preference information and prompt generation based on user feedback. Such a technique should improve the functioning of the computer system itself by providing an integrated pipeline that more efficiently converts raw behavior data into high-quality recommendations and transparent, consistent explanations generated by a generative AI model.

The specific processing by the specific processing unit 290 of the data processing device 12 in Example 2 is realized by the following means.

The present invention provides a server comprising a processor and a storage device, the processor being configured to acquire, from a user terminal via a communication network, user input information and behavior history information including location information and purchase history information, store the behavior history information in a behavior history storage area of the storage device, preprocess the behavior history information using data analysis software to generate behavior feature data, execute, using machine learning software, a classification process or a clustering process on the behavior feature data to estimate user preference information and record the user preference information in a preference storage area, acquire region-related information including regional statistical information, real-estate information, and evaluation information from an external information providing device via the communication network and store the region-related information in a region information storage area, calculate, using numerical computation software, a suitability index for each candidate region based on the user preference information and the region-related information and specify a candidate region suitable for the user, generate structured data including at least the user preference information, the region-related information, and the candidate region, generate a prompt sentence including the structured data and instructing a generative AI model to describe candidate regions that satisfy user conditions, input the prompt sentence and the structured data into the generative AI model and obtain, from the generative AI model, an explanation result in a natural language including at least a selection reason of the candidate region and an explanation of the user preference, and transmit the candidate region, the suitability index, and the explanation result to the user terminal via the communication network. This enables an integrated, computer-implemented pipeline that converts raw behavior history into optimized region recommendations with consistent, data-grounded natural language explanations, thereby improving the technical functioning of the recommendation system in terms of data processing efficiency, model adaptability, explanation accuracy, and overall computational performance.

The term “user terminal” refers to an information processing apparatus operated by a user, such as a mobile communication device, a portable computing device, or a stationary computing device, that is capable of transmitting data to and receiving data from a server via a communication network.

The term “communication network” refers to a wired or wireless data transmission infrastructure, such as the Internet, a local area network, a wide area network, or a cellular communication network, that enables data exchange between the user terminal, the server, and external information providing devices.

The term “user input information” refers to data explicitly provided by a user through a user interface of the user terminal, including but not limited to preference settings, constraint conditions, evaluation inputs, and other configuration data related to recommendation processing.

The term “behavior history information” refers to data representing past actions of a user, including at least location information and purchase history information, that is collected from the user terminal and stored for analysis.

The term “location information” refers to data indicating a geographical position of the user or the user terminal, such as coordinate values, timestamps, and identifiers of visited places, obtained from a positioning function of the user terminal.

The term “purchase history information” refers to data indicating transactions made by the user, such as purchased item identifiers, item categories, transaction timestamps, amounts, and related store or service information.

The term “storage device” refers to a hardware or virtualized component capable of storing digital data, including but not limited to magnetic storage, semiconductor storage, optical storage, or cloud-based storage resources.

The term “behavior history storage area” refers to a logical data region within the storage device that is allocated to store behavior history information associated with one or more users.

The term “data analysis software” refers to a software component or library executed by the processor to perform preprocessing operations on data, including deletion of duplicate data, completion of missing values, removal of abnormal values, aggregation, and transformation into feature representations.

The term “behavior feature data” refers to structured data derived from behavior history information, representing characteristics of user behavior in a numerical or categorical form suitable for processing by machine learning software.

The term “machine learning software” refers to a software component or library configured to execute training and inference of machine learning models, including at least classification processing and clustering processing, based on behavior feature data and, optionally, labeled data.

The term “classification process” refers to a computational procedure in which machine learning software assigns one or more discrete labels to input behavior feature data according to a learned model.

The term “clustering process” refers to a computational procedure in which machine learning software partitions input behavior feature data into groups without explicit labels, based on similarity measures or distance metrics.

The term “user preference information” refers to data indicating inferred or estimated tendencies, interests, or orientations of a user, represented as labels, scores, or probability values, and derived from the behavior feature data by the machine learning software.

The term “preference storage area” refers to a logical data region within the storage device that is allocated to store user preference information associated with one or more users.

The term “external information providing device” refers to an information processing apparatus or service that supplies region-related information to the server via the communication network, including but not limited to data servers, information platforms, and remote databases.

The term “region-related information” refers to data describing attributes of geographic regions, including at least regional statistical information, real-estate information, and evaluation information used for recommendation processing.

The term “regional statistical information” refers to data indicating statistical properties of a region, such as population-related metrics, safety indices, transportation availability, and environmental indicators.

The term “real-estate information” refers to data describing properties and housing conditions in a region, including but not limited to rental prices, sale prices, property types, availability, and floor area.

The term “evaluation information” refers to data indicating assessments or ratings of a region or facilities in the region, such as user reviews, scores, rankings, or qualitative comments.

The term “region information storage area” refers to a logical data region within the storage device that is allocated to store region-related information corresponding to multiple candidate regions.

The term “numerical computation software” refers to a software component or library executed by the processor to perform arithmetic operations, statistical calculations, and other numerical processing for computing suitability indices and related metrics.

The term “suitability index” refers to a numerical value or score calculated for each candidate region based on user preference information and region-related information, indicating a degree of suitability of the region for the user.

The term “candidate region” refers to a geographic area selected for evaluation as a potential recommendation target for the user, for which a suitability index is computed.

The term “structured data” refers to data organized in a predefined format such as a table, record, list, or hierarchical representation, including fields for user preference information, region-related information, and candidate regions, which can be directly processed by software.

The term “prompt sentence” refers to a text or text-like instruction sequence, including at least structured data and explicit guidance, that is provided as input to a generative AI model to control the content, scope, and style of a generated natural language output.

The term “generative AI model” refers to a trained artificial intelligence model configured to generate natural language text or other content based on input data and a prompt sentence, using machine learning techniques.

The term “explanation result” refers to natural language output generated by the generative AI model, including at least a reason for selecting a candidate region and an explanation of user preference information.

The term “user interface” refers to a functional layer, including graphical, textual, or interactive components, through which a user terminal presents information to the user and obtains input from the user.

The term “evaluation information regarding recommendation results” refers to data indicating user reactions or assessments of recommended candidate regions, such as approval signals, disapproval signals, selection actions, or feedback comments, which are transmitted from the user terminal to the server.

In one embodiment, a server implements the claimed system as a network-accessible recommendation platform. The server includes at least one central processing unit (CPU), a main memory, a non-volatile storage device, and a network interface coupled via a bus. The server executes an operating system such as a general-purpose server operating system and application software implemented, for example, in a high-level programming language. The server further executes specific software modules including a data collection module, a data preprocessing module based on a data analysis library (for example, a tabular data processing library), a machine learning module using a machine learning library (for example, a library providing classification and clustering algorithms), a numerical computation module using a numerical array processing library, a generative AI interface module for communicating with a generative AI model, and a user interface module for controlling data exchange with terminals.

A terminal is, for example, a smartphone, a tablet computer, or a personal computer operated by a user. The terminal includes a processor, a memory, a wireless or wired communication interface, one or more sensors including at least a positioning sensor, a display device, and input devices such as a touch panel or a pointing device. The terminal executes an operating system such as a mobile or desktop operating system and runs an application or browser-based client which communicates with the server via a communication network such as the Internet or a mobile communication network.

A user interacts with the terminal to provide explicit preference information and evaluation information. The terminal displays graphical user interface elements such as forms, buttons, and sliders and transmits user input information to the server in a structured message format. The terminal also acquires behavior history information by using hardware components. For example, the terminal obtains location information by reading sensor values from a positioning subsystem (e.g., a GNSS receiver combined with inertial sensors) and associates timestamps with sampled coordinates. The terminal obtains purchase history information from installed applications or services via exposed application programming interfaces, where available. The terminal aggregates these data into messages and transmits them to the server using secure network protocols.

The server receives the behavior history information and stores it in a behavior history storage area within the storage device. In one implementation, the server uses a relational database system to manage tables representing user locations and user purchases. Each location record includes at least a user identifier, a timestamp, a latitude, a longitude, and an optional place identifier. Each purchase record includes at least a user identifier, a timestamp, an item category identifier, an item price, and an optional store identifier. The server thus maintains a persistent, queryable representation of user behavior history.

The server preprocesses the stored behavior history information by executing the data preprocessing module. The data preprocessing module loads relevant records from the relational database into in-memory tabular data structures provided by the data analysis library. The server applies specific operations that include removing duplicate entries based on overlapping timestamps and identical coordinate pairs, filling missing values using interpolation or default category assignment, and discarding abnormal values based on numeric thresholds such as maximum allowed distance traveled per unit time. The server further aggregates the behavior history information into behavior feature data by grouping records per user and computing derived metrics. Examples of derived metrics include, for each user, counts of visits to regions classified as sightseeing areas, counts of visits to commercial districts, average distance traveled per day, time-of-day histograms of visits, and frequency of purchases per category such as imaging devices, travel-related goods, or home-related goods.

The server encodes these derived metrics into feature vectors suitable for machine learning processing. The server uses numerical arrays, where each dimension corresponds to a specific feature, such as the number of sightseeing visits normalized by a total number of visits, or the proportion of purchases in a particular category. The server may use feature scaling techniques such as min-max normalization or standardization. As a result, the behavior feature data constitute a structured, high-dimensional representation of user behavior that is not directly observable by a human operator. This transformation improves data management and computational efficiency because subsequent machine learning operations operate on compact numeric vectors instead of raw event logs.

The server estimates user preference information by executing the machine learning module. In one embodiment, the machine learning module includes both a clustering model and a classification model. The clustering model may be implemented as a centroid-based algorithm such as k-means, which partitions user feature vectors into clusters according to Euclidean distance. The server determines cluster centroids that represent typical behavior patterns, for example, a “sightseeing-oriented cluster” with high normalized counts of visits to sightseeing spots and high proportions of imaging-related purchases, and a “quiet-residential cluster” with higher proportions of visits to parks and lower activity in commercial districts. The classification model may be implemented as a logistic regression model or a tree-based ensemble model such as a random forest, trained on labeled data where each user or session is annotated with preference categories such as sightseeing orientation, imaging orientation, urban orientation, or quietness orientation. The server uses a loss function such as cross-entropy and applies gradient-based optimization to adjust model parameters during training.

The server executes the machine learning models on the feature vectors to infer, for each user, preference scores. For example, the server computes probability values indicating the degree to which the user belongs to a sightseeing-oriented category, an imaging-oriented category, an urban-oriented category, and a quietness-oriented category. The server records these values as user preference information in the preference storage area. This machine-based estimation uses correlations and high-dimensional patterns that are not feasible to detect manually, and thus goes beyond mere automation of explicit user preference selection.

The server also acquires region-related information from external information providing devices. These external devices expose application programming interfaces that supply regional statistical information, real-estate information, and evaluation information. The server periodically sends requests to such external devices and receives structured responses that include, for example, population density, crime indices, average rent values, number of public transport stations, number of tourist attractions, and aggregated rating scores for facilities in each region. The server stores this region-related information in a region information storage area in the database. The server may normalize different data sources into a unified region identifier space and may generate region feature vectors analogous to user feature vectors.

The server calculates a suitability index for each candidate region by executing the numerical computation module. The numerical computation module implements a weighted scoring function that multiplies elements of the user preference information by corresponding region attributes. For instance, a high sightseeing orientation weight increases the importance of the number of tourist attractions in a region, and a high imaging orientation weight increases the importance of scenic viewpoints, while a quietness orientation weight increases the influence of noise level indices and park area per capita. The server uses vectorized operations in the numerical array processing library to compute scores for a large number of regions simultaneously, reducing computational time compared to iterative processing. The server may also enforce constraints such as budget limits or commuting time thresholds by adjusting scores or removing regions that do not satisfy these constraints. By combining learned preference weights with region attributes in a systematic, algorithmic manner, the server produces suitability indices that are both quantitatively grounded and efficiently computed.

The server then generates structured data representing the context for explanation generation. The structured data include at least the user preference information, region-related information for selected candidate regions with high suitability indices, and identifiers of these regions. The server formats this structured data as a human-readable yet machine-parseable sequence, such as ordered key-value pairs or delimited sections. The server uses this structured data to construct a prompt sentence for a generative AI model.

The server executes the generative AI interface module to generate the prompt sentence. In one embodiment, the generative AI model is a large-scale neural network model based on a transformer architecture, with multiple layers of self-attention and feedforward sub-layers, trained on large text corpora. The server does not retrain the base generative AI model but controls its behavior by constructing a precise prompt sentence that embeds the structured data and specifies the required output format. The following is an example of such a prompt sentence:

“Based on the following user behavior history, inferred preferences, and candidate residential regions, explain what the user likely prefers and justify which regions are suitable and why. Be concise but specific.

User behavior history: visited multiple sightseeing spots including a major tower, a historical temple area, and a theme park; purchased a digital single-lens reflex camera and several travel guidebooks.

Inferred preference profile: strong interest in sightseeing (0.92), strong interest in photography (0.88), high preference for vibrant urban centers (0.81), low preference for quiet suburban areas (0.19).

Candidate regions: Region A located near a central landmark with a high density of tourist spots and photo locations, high rent level; Region B located in a historical district with very high density of sightseeing spots and medium rent level.”

The server may include numeric suitability indices and specific attributes in the prompt sentence, thereby constraining the generative AI model to base its explanation on actual computed data rather than on assumptions. By embedding structured data into the prompt sentence, the server effectively binds the generative AI output to the internal computational logic of the recommendation system, improving consistency and explainability.

The generative AI model processes the prompt sentence and generates an explanation result in natural language. Internally, the generative AI model applies its learned transformer layers, where each layer calculates attention weights over the input token sequence, including both textual context and embedded data values, to produce context-aware hidden representations. These representations are propagated through multiple layers and are used to predict subsequent tokens according to a probability distribution parameterized by learned weights. Because the prompt sentence is constructed to include explicit numerical preference scores and region features, the internal attention mechanisms focus on relevant segments, which leads to output that more accurately reflects the computed suitability indices. This improves explanation accuracy compared to naive natural-language generation without data grounding.

The server receives the generated explanation result and associates it with the corresponding user and candidate regions. The server then transmits the candidate regions, their suitability indices, and the explanation result to the terminal. The terminal displays this information via a user interface. The user can read how the system interpreted the behavior history and why certain regions are suggested, which strengthens user trust and facilitates informed decision-making about real-world residential choices.

From a technical perspective, this integrated approach offers improvements over conventional systems. The preprocessing and feature extraction pipeline reduces raw data volume and enforces consistent data formats, which leads to reduced storage overhead and improved cache behavior in the database engine. The vectorized numerical computations reduce processor cycles for scoring regions at scale. The use of machine-learned preference estimation replaces simplistic rule-based filters and provides finer-grained personalization, resulting in a lower error rate in matching user interests to region characteristics. The embedding of structured data into the prompt sentence for the generative AI model ensures that the generative component operates under explicit constraints and yields outputs that can be validated against the underlying data, reducing the incidence of hallucinated or inconsistent explanations.

The system also incorporates a feedback loop. The user can use the terminal to express evaluations such as approval or disapproval of recommended regions. The terminal transmits this evaluation information to the server. The server stores this information and uses it as labeled data to update the classification model. Specifically, the server may adjust model weights by minimizing an augmented loss function that includes misclassification of user evaluations. The server may also adjust feature weighting schemes for computing suitability indices, thereby gradually aligning recommendation logic with observed user behavior. This closed-loop learning improves model adaptability and reduces the need for manual rule maintenance.

The described configuration goes beyond simply automating a human decision-making process. The server uses a combination of specialized data structures (feature vectors, preference vectors, region attribute vectors, and suitability indices), specific algorithms (clustering, classification, vectorized weighted scoring), and a coordinated interaction between discriminative models and a generative AI model. The data flow from raw sensor readings and transactional logs, through preprocessing, feature extraction, model-based preference estimation, and numeric scoring, to constrained natural language explanation, constitutes a technical architecture that improves computing efficiency, enhances accuracy of predictions, and provides a repeatable, verifiable explanation mechanism.

In alternative embodiments, the server may employ different machine learning algorithms, such as gradient boosting decision trees or neural network classifiers, in place of or in addition to logistic regression or random forests. The server may also use different clustering algorithms such as density-based clustering for users with irregular behavior patterns. The generative AI model may be hosted locally on the server or accessed as a remote service; in a local hosting scenario, the server may further optimize inference by quantizing model weights or partitioning the model across multiple GPU devices, thereby reducing latency. The server may also vary the structure of the prompt sentence, for example by including explicit instructions to output explanations in bullet-point form, or by constraining the explanation to mention only regions with suitability indices above a threshold.

In other variations, the terminal may incorporate additional sensors such as motion sensors, environmental sensors, or proximity sensors, and the server may incorporate such sensor data into behavior feature data. The server may also adjust sampling intervals or data upload frequency based on network conditions and server load, thereby reducing communication load while maintaining adequate data freshness for accurate recommendation generation. These variations remain within the scope of the claimed system, as they use the same fundamental architecture of behavior history acquisition, feature-based preference estimation, region scoring, structured prompt construction, and generative AI-based explanation.

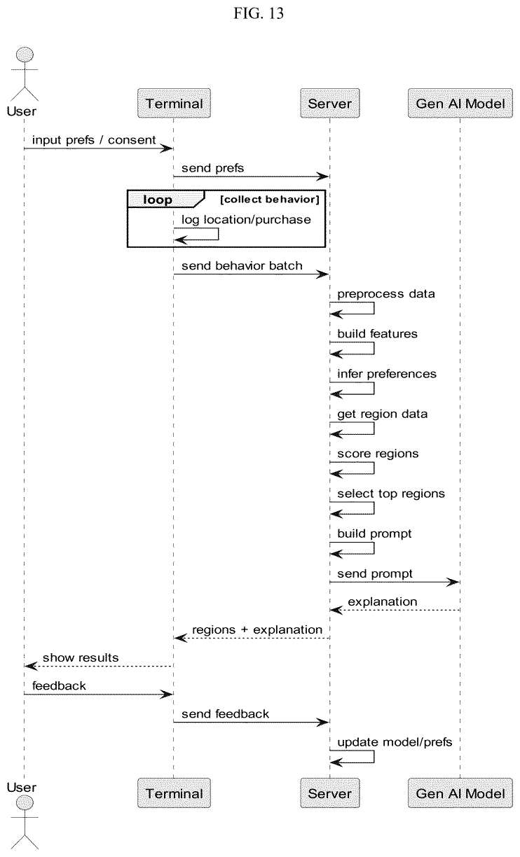

The following describes the processing flow using FIG. 13.

### Step 1

User operates the terminal to provide consent and initial preference input.

User views a graphical user interface on the terminal and selects options such as budget range, desired commuting time, and general area preferences. User also grants permission for location tracking and access to purchase information by tapping consent buttons.

Input: User touch operations and textual selections.

Output: A structured preference and consent record stored on the terminal.

Terminal converts the user selections into key-value pairs (for example, preferred budget range, preferred urban/quiet level) and stores them temporarily in local memory for later transmission to the server.

### Step 2

Terminal transmits user input information and consent information to the server.

Terminal establishes a secure HTTPS connection to the server and sends a request message containing the structured preference and consent record along with a user identifier or authentication token.

Input: Locally stored preference and consent record.

Output: A request payload delivered to the server and an acknowledgment response received from the server.

Terminal serializes the record into a message format, attaches headers for authentication, and sends the message through a communication interface. When the server responds with a success code, the terminal logs that the initial configuration has been synchronized.

### Step 3

Terminal acquires behavior history information comprising location information.

Terminal periodically accesses a positioning subsystem (for example, a GNSS receiver and motion sensors) to read current coordinates and timestamps. Terminal records each sample as a visit event when movement exceeds a predefined distance threshold or when a fixed time interval elapses.

Input: Raw sensor measurements such as latitude, longitude, and time.

Output: A sequence of location events representing the user's visit history.

Terminal aggregates these location events in local storage, associating them with region identifiers when possible by performing reverse geocoding through a mapping service or cached mapping data.

### Step 4

Terminal acquires behavior history information comprising purchase history information.

Terminal communicates with installed commerce or payment applications via exposed application programming interfaces, where permitted by the user, to retrieve item identifiers, item categories, transaction times, and transaction amounts.

Input: API responses from local applications or services containing transaction logs.

Output: A list of purchase events containing item category, timestamp, and amount.

Terminal converts each transaction into a standardized purchase record and stores it in a local queue for later upload to the server.

### Step 5

Terminal transmits behavior history information to the server.

Terminal checks network connectivity and, when available, initiates a background upload process. Terminal composes a single batch message containing multiple location events and purchase events and sends this batch to the server via HTTPS.

Input: Buffered location events and purchase events stored on the terminal.

Output: A behavior history upload request delivered to the server and a synchronization status returned to the terminal.

Terminal marks uploaded events as synchronized only after receiving a success status from the server, thereby preventing data loss and avoiding duplicate uploads.

### Step 6

Server receives and stores behavior history information.

Server listens on an application programming interface endpoint and verifies authentication tokens for incoming requests. Server parses the request body to extract location and purchase events.

Input: Batch message containing multiple location and purchase records.

Output: Normalized records inserted into behavior history tables in a database.

Server inserts each event into tables such as a location table and a purchase table, filling fields for user identifier, timestamp, coordinates, item category, and amount. Server also generates primary keys and indexes on fields such as user identifier and time to optimize later queries.

### Step 7

Server performs data preprocessing on behavior history information.

Server uses a data analysis module to load location and purchase records for a given user into in-memory tables. Server applies operations to remove duplicates where coordinates and timestamps are identical within a small time window, to discard unrealistic jumps calculated by comparing distance over time, and to fill missing categories for purchases by mapping item identifiers to known categories.

Input: Raw location and purchase records read from the behavior history tables.

Output: Cleaned and normalized behavior tables without duplicates, with corrected or supplemented fields.

Server computes values such as distance traveled per segment using coordinate formulas, identifies outliers using thresholds on speed, and updates or deletes rows accordingly, thereby preparing the data for feature extraction.

### Step 8

Server generates behavior feature data for each user.

Server aggregates the cleaned event data by user and by category. For location data, server counts visits to region types such as sightseeing areas, commercial districts, residential districts, and parks. For purchase data, server sums or counts items by category such as imaging equipment, travel-related goods, and household goods.

Input: Cleaned location and purchase event tables for a user.

Output: A feature vector or feature record representing frequencies and proportions of user behavior across categories.

Server calculates normalized values, for example dividing the number of visits to sightseeing areas by the total number of location events, and stores these numerical values in a feature table. This conversion from event lists to compact numeric feature vectors reduces the amount of data for subsequent processing.

### Step 9

Server estimates user preference information using machine learning software.

Server loads a trained classification or clustering model and feeds the user's feature vector into the model. The model, which may be a logistic regression classifier or a tree-based ensemble, computes probability values for preference labels such as sightseeing orientation, imaging orientation, urban orientation, and quietness orientation.

Input: Behavior feature vector of a specific user and stored parameters of a trained model.

Output: User preference scores for each preference category, forming user preference information.

Server applies matrix multiplication and non-linear activation functions as defined by the model structure, computes a loss function during training phases, and updates weights by gradient-based optimization. In inference, server only performs the forward pass to obtain preference scores, which are then written into a preference storage area.

### Step 10

Server acquires and normalizes region-related information.

Server periodically sends requests to external information providing devices to obtain data such as regional statistics, real-estate values, and evaluation scores. Server receives structured responses and maps them to standardized region identifiers.

Input: External responses containing raw region attributes and identifiers.

Output: Region feature records stored in region information tables with consistent identifiers.

Server converts external units (for example, different currencies or time units) into standardized units and fills missing attributes by interpolation or by using default values, ensuring that every candidate region has a complete attribute vector.

### Step 11

Server calculates suitability indices for candidate regions.

Server retrieves the user preference information and region attribute vectors for all regions. Server computes a weighted sum or similar scoring function where each region attribute is multiplied by a corresponding weight derived from the user's preference scores.

Input: User preference vector and region attribute vectors.

Output: A suitability index for each region associated with the user.

Server executes vectorized arithmetic operations to calculate these scores for many regions simultaneously and applies constraints such as budget or commuting time by setting scores to zero or discarding regions that do not satisfy these constraints. The resulting suitability indices form a ranked list of candidate regions.

### Step 12

Server selects candidate regions and composes structured explanation context.

Server sorts regions by suitability index in descending order and selects a fixed number of top-ranked regions as candidate regions. Server then collects region attributes, user preference scores, and, optionally, key behavior examples to form a context dataset.

Input: List of suitability indices and corresponding region identifiers, and user preference information.

Output: A structured context dataset including selected region identifiers, their attributes, and summary of user preferences and behavior.

Server constructs a textual representation of this dataset, organizing it into labeled sections such as “Inferred preference profile” and “Candidate regions,” which are suitable for inclusion in a prompt sentence.

### Step 13

Server generates a prompt sentence for a generative AI model.

Server uses the context dataset to construct a detailed prompt sentence that instructs a generative AI model to produce a natural language explanation grounded in the computed data.

Input: Structured context dataset containing user preference information, behavior summary, and candidate region descriptions with suitability indices.

Output: A prompt sentence in text format ready to be transmitted to the generative AI model.

Server, for example, generates a prompt sentence such as: “Based on the following user behavior history, inferred preferences, and candidate residential regions, explain what the user likely prefers and justify which regions are suitable and why. Be concise but specific.

User behavior history: visited multiple sightseeing spots including a major tower, a historical temple area, and a theme park; purchased a digital single-lens reflex camera and several travel guidebooks.

Inferred preference profile: strong interest in sightseeing (0.92), strong interest in photography (0.88), high preference for vibrant urban centers (0.81), low preference for quiet suburban areas (0.19).

Candidate regions: Region A located near a central landmark with a high density of tourist spots and photo locations, high rent level; Region B located in a historical district with very high density of sightseeing spots and medium rent level.”

### Step 14

Server transmits the prompt sentence to the generative AI model and obtains an explanation result.

Server sends a request to the generative AI model's interface, including the prompt sentence and any required control parameters such as maximum output length and temperature. The generative AI model processes the prompt internally, applying its learned parameters to generate an explanation.

Input: Prompt sentence containing structured context and instructions.

Output: Natural language explanation text describing user preferences and reasons for selecting candidate regions.

Server receives the generated text, verifies that it contains required elements such as references to candidate regions and preferences, and discards or truncates irrelevant parts if necessary.

### Step 15

Server associates the explanation result with candidate regions and prepares a response to the terminal.

Server combines the explanation text with the list of candidate regions and their suitability indices into a response object.

Input: Candidate region list with suitability indices and explanation result from the generative AI model.

Output: A recommendation response message including region identifiers, scores, and explanation text.

Server formats the response as a structured message and stores a copy in a recommendation history table for future auditing and learning.

### Step 16

Terminal receives and displays recommendation results and explanation.

Terminal sends a request to the server for updated recommendations and receives the recommendation response message.

Input: Recommendation response containing candidate regions, suitability indices, and explanation text.

Output: A visual presentation of recommended regions and explanations on the terminal display.

Terminal renders a ranked list of regions, shows key attributes such as estimated rent and distance to central areas, and displays the explanation text in a readable format. User can scroll through the list, tap on individual regions to see details, and read how the system interpreted their behavior.

### Step 17

User provides feedback on recommendation results via the terminal.

User inspects the recommended regions and the explanation and interacts with the user interface elements to indicate approval, disapproval, or interest in specific regions.

Input: User operations such as tapping “like,” “dislike,” or “save” buttons for each region.

Output: A set of feedback records stored locally on the terminal.

Terminal encodes each feedback action as a record with a region identifier, a feedback type, and a timestamp, preparing the data for upload to the server.

### Step 18

Terminal transmits feedback information to the server.

Terminal initiates an upload process for feedback records, similar to behavior history uploads, and sends a feedback message to the server via HTTPS.

Input: Locally stored feedback records associated with recommendation results.

Output: A feedback message delivered to the server and an acknowledgment response received.

Terminal, upon success, marks feedback records as synchronized and may delete or archive them locally.

### Step 19

Server updates user preference information based on feedback and regenerates prompt sentences when needed.

Server reads the feedback records and correlates them with previous recommendation instances and stored preference information. Server adjusts model parameters or feature weights, for example by treating “like” actions as positive labels and “dislike” actions as negative labels in a supervised learning update of the classification model.

Input: Feedback records, prior user preference scores, and past recommendation data.

Output: Updated user preference information and, optionally, updated model parameters and revised prompt sentences for future recommendation cycles.

Server recalculates loss functions considering the feedback labels and updates weights through gradient-based optimization. Server then computes new preference scores for the user and, when generating subsequent prompt sentences, incorporates the updated scores to refine the explanation and recommendation content.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented recommendation systems for residential areas, transportation hubs, and commercial facilities typically rely on fixed scoring rules or isolated machine-learning models operating on limited structured data. Such systems often ingest user inputs and external datasets, compute heuristic scores, and directly output a ranked list to a user interface. These approaches exhibit several technical shortcomings.

First, existing systems generally treat user preference estimation, external data aggregation, spatial analysis, and natural-language explanation as separate and loosely coupled modules. There is no unified computational pipeline in which user behavior logs, multi-source region data, geographic relationships, and text-based explanations are jointly modeled. As a result, the server hardware must execute multiple redundant data transformations and inconsistent models, leading to inefficient processor utilization, increased memory consumption, and higher network overhead.

Second, many systems lack a structured mechanism to transform internal numerical and symbolic representations (e.g., user feature vectors, region feature vectors, emotion scores, geographic relations) into machine-readable instructions for a generative AI model. In practice, ad hoc or manually crafted prompts are used, which do not consistently reflect the internal state of the recommendation engine. This reduces the accuracy and reproducibility of the generative AI output and prevents the system from leveraging the full expressive power of large-scale generative models in a controlled way.

Third, known techniques often ignore or underutilize emotion analysis derived from user behavior history and user-generated text. Emotion states, when used at all, are typically handled as separate metadata and are not systematically integrated into numerical preference modeling or into the construction of prompts sent to generative AI models. Accordingly, the processor is not configured to adjust its ranking computations and textual outputs based on dynamically updated emotion states, which degrades personalization and can result in recommendations that are inconsistent with the user's current affective context.

Fourth, spatial relationships among regions and transportation hubs are frequently processed only at the presentation layer, for example by overlaying map tiles in a client application. The server processor, however, does not perform integrated geographic information processing together with preference estimation and prompt construction. This leads to additional client-side processing, fragmented logic between client and server, and missed opportunities for optimizing the end-to-end computation of geographically grounded recommendations.

Accordingly, there is a need for a computer-implemented system and server architecture in which a processor is specifically configured to: (i) generate user preference feature information from behavioral and usage history data, (ii) obtain and normalize multi-source region and facility data into region feature information, (iii) apply statistical or machine-learning processing to estimate latent user preference, (iv) apply geographic information processing to select candidate regions and transportation hubs, (v) integrate emotion analysis into the weighting of preference and region selection, and (vi) automatically construct and supply structured prompt sentences to a generative AI model based on internal feature information and spatial relationships. By tightly coupling these computational steps inside the processor, the system can improve the efficiency, consistency, and technical quality of recommendation generation and explanation compared to conventional systems.

The specific processing by the specific processing unit 290 of the data processing device 12 in Application Example 2 is realized by the following means.

The present invention provides a server comprising a processor configured to acquire preference conditions and behavioral information from a user and usage history information from a terminal, generate user preference feature information based on the behavioral information and the usage history information, obtain region information and facility information from a plurality of information sources via a network and convert the region information and the facility information into numerical and normalized region feature information, estimate latent user preference by associating the user preference feature information with the region feature information using statistical processing or machine learning processing, assign spatial information to the region feature information using a geographic information processing function and select candidate regions and candidate transportation hubs based on the latent user preference, generate explanatory data including the user preference feature information, the latent user preference, the candidate regions, the candidate transportation hubs, and numerical indices related thereto, perform emotion analysis on user behavior history data and user text input to estimate an emotion state for each region or facility and weight at least one of the user preference feature information and the selection of the candidate regions based on the emotion state, automatically format summary information including the user preference feature information, the emotion state, the region feature information, and spatial relationships of the candidate transportation hubs into a text form interpretable by a generative AI model, construct a prompt sentence including the summary information for causing the generative AI model to perform prediction and explanation regarding the candidate regions and the candidate transportation hubs, input the prompt sentence to the generative AI model and obtain a proposal result in natural language regarding the candidate regions and the candidate transportation hubs from the generative AI model, and integrate the proposal result with the numerical indices to form recommendation information and cause a user interface to display the recommendation information. This enables an integrated server-side computation pipeline in which user feature generation, multi-source data normalization, emotion-weighted preference estimation, geographic selection of regions and transportation hubs, and prompt-based invocation of a generative AI model are coherently executed within the processor, thereby improving the technical efficiency, scalability, and personalization accuracy of computer-implemented recommendation and explanation processes.

The term “preference conditions” refers to constraint information and desired attributes for a region, transportation hub, facility, or service, which are explicitly provided by a user through an input interface, such as text fields, check boxes, sliders, or selection menus.

The term “behavioral information” refers to data indicating actual actions performed by a user, including at least visiting locations, accessing digital content, or purchasing goods or services, as obtained from device logs, application logs, or network logs.

The term “usage history information” refers to records of interactions between a user and a terminal or application, including access times, viewed screens, clicked elements, and session statistics, which are stored over time and can be analyzed as a temporal sequence.

The term “terminal” refers to a client-side computing apparatus, such as a mobile device, a tablet device, a personal computer, or a browser-executing device, which is capable of communicating with a server via a communication network.

The term “user preference feature information” refers to numerical or symbolic feature values derived from behavioral information, usage history information, and preference conditions, which represent characteristics of a user's likes, dislikes, or tendencies in a format suitable for statistical processing or machine learning processing.

The term “region information” refers to data describing geographic areas, such as neighborhoods, districts, or zones, including attributes like safety levels, commercial density, environmental conditions, or infrastructure availability.

The term “facility information” refers to data describing specific points of interest, such as commercial establishments, public institutions, or service-providing entities, including attributes such as category, rating, price level, and operational status.

The term “information sources” refers to external or internal data providers, including databases, application programming interfaces, web services, or document repositories, which can be accessed via a network to obtain region information or facility information.

The term “region feature information” refers to numerical or normalized representations of properties of regions, derived from region information and facility information, including at least scores or indices related to safety, density of facilities, and environmental characteristics.

The term “statistical processing” refers to computational operations based on statistical methods, such as aggregation, normalization, regression, clustering, or correlation analysis, which are performed on feature information to infer or adjust relationships among variables.

The term “machine learning processing” refers to computation using a trained model that learns patterns from data, such as classification, regression, ranking, or embedding, in order to predict or estimate outputs including user preference or recommendation scores.

The term “latent user preference” refers to preference characteristics of a user that are not directly observed in raw input data but are inferred by statistical processing or machine learning processing from user preference feature information and region feature information.

The term “geographic information processing function” refers to a computational capability for handling spatial data, including operations such as coordinate transformation, spatial indexing, spatial joins, and distance calculations, often implemented using geographic information system software or libraries.

The term “candidate regions” refers to a set of regions that have been selected from multiple regions based on latent user preference and region feature information, and which are considered as potential recommendation targets.

The term “candidate transportation hubs” refers to transportation-related locations, such as stations, stops, or terminals, which are selected in association with candidate regions based on spatial relationships and user preference criteria.

The term “explanatory data” refers to internally generated data structures that summarize user preference feature information, latent user preference, candidate regions, candidate transportation hubs, and related numerical indices, in a form suitable for constructing human-readable or machine-readable explanations.

The term “numerical indices” refers to scalar or vector values representing quantified metrics, such as scores, ratings, densities, or distances, which characterize properties of users, regions, or facilities.

The term “emotion analysis” refers to computational processing of text or behavior data to estimate affective states, such as positivity, negativity, stress, or satisfaction, using natural language processing techniques or emotion detection algorithms.

The term “emotion state” refers to a representation of a user's affective condition, expressed as a label, score, or probability distribution, which may be associated with a user globally or with a specific region or facility.

The term “summary information” refers to a condensed representation of multiple types of internal data, including user preference feature information, emotion state, region feature information, and spatial relationships, arranged in a structured or semi-structured format for further processing.

The term “spatial relationships” refers to relationships between geographic entities, such as proximity, containment, adjacency, or connectivity, expressed using coordinates, distances, or topological descriptors.

The term “prompt sentence” refers to a text string or set of text strings that encode instructions, constraints, and contextual data to be supplied as input to a generative AI model, in order to cause the model to generate prediction or explanation outputs relevant to candidate regions or candidate transportation hubs.

The term “generative AI model” refers to a computational model based on artificial intelligence, which generates text or other data in response to an input, such as a prompt sentence, by probabilistically predicting subsequent tokens or structures based on learned parameters.

The term “proposal result” refers to output information, expressed in natural language or structured format, generated by a generative AI model in response to a prompt sentence, describing recommended regions, transportation hubs, facilities, or related explanations.

The term “recommendation information” refers to data provided to a user as a result of processing by the system, including at least proposal results combined with numerical indices, and optionally including rankings, lists, and justification texts.

The term “user interface” refers to any hardware or software component that presents information to a user or receives input from a user, including graphical interfaces, web pages, mobile application screens, and interactive controls.

In one embodiment, a server executes a recommendation system that generates personalized proposals for regions, transportation hubs, and facilities based on user preference conditions, behavioral information, usage history information, multi-source region information, and outputs from a generative AI model. The server operates as a network-accessible computing apparatus including at least one multi-core processor, a main memory, a non-volatile storage device, and a network interface. The server runs an operating system such as a general-purpose server operating system, and executes application software implemented, for example, in a high-level programming language. The server communicates with at least one terminal over a wired or wireless communication network. The terminal operates as a client device such as a smartphone, a tablet, or a personal computer, and provides a user interface that allows a user to input preference conditions and view recommendation results.

The server stores in a storage device various software modules that implement different functional components of the system. In one example, the server stores a data collection module, a feature generation module, a statistical and machine-learning module, a geographic information processing module, an emotion analysis module, a prompt generation module, a generative AI interaction module, and a recommendation assembly module. The server further stores structured data in one or more databases, such as a relational database and a spatial database. In one configuration, the server uses a relational database engine and a spatial extension as geographic information system software for storing region polygons, facility coordinates, and spatial indices.

The terminal acquires preference conditions and usage history information from the user. The user operates a graphical interface on the terminal to input preference conditions, such as desired safety level, desired commercial richness, preference for quietness, and preference for specific facility categories. The terminal also records usage history information, such as screens viewed, recommendation items selected, and time spent on each interface. The terminal periodically or on demand transmits these preference conditions and usage history information to the server via a network protocol, such as HTTPS, in a structured format.

The server acquires behavioral information from the terminal and other external systems. The terminal, for example, supplies logs of locations visited by the user, categories of places visited, and purchase events. In some embodiments, the server acquires additional behavioral information from online services through application programming interfaces, such as transaction history from commerce platforms or check-in history from location-based services. The server stores behavioral information and usage history information in user-specific tables or collections.

The server uses the feature generation module to transform behavioral information, usage history information, and preference conditions into user preference feature information. In one implementation, the server constructs a feature vector for each user. The feature vector includes, for example, frequency counts of visits to different facility categories, temporal distributions of visits, average travel distance per day, and binary indicators representing whether certain preference conditions are selected. The server normalizes each feature dimension using methods such as min-max scaling or z-score normalization. The server also encodes categorical attributes into numeric representations using one-hot encoding or embedding indices.

The server acquires region information and facility information from a plurality of information sources via a network. The data collection module retrieves data from public databases, review sites, mapping services, and local open data portals. The server parses semi-structured documents and application programming interface responses to extract attributes such as crime statistics, counts of specific facility categories, average ratings, and price levels. The server uses a parser library or similar text-processing library to extract values from received documents and to populate structured tables including region identifiers, attribute values, and coordinate geometries.

The server uses the feature generation module to convert region information and facility information into region feature information. The server aggregates facility counts by region, calculates densities of different facility types per unit area, and generates safety scores based on crime statistics. The server further calculates metrics expressing noise levels, environmental qualities, or other factors based on available attributes. The server normalizes these metrics, for example by mapping raw values into a fixed numerical range. The server thereby generates region feature vectors representing each region in a consistent numerical space.

The server assigns spatial information to region feature information using the geographic information processing module. The server stores region geometries and facility locations as spatial data types, and creates spatial indices to accelerate spatial queries. The server uses spatial functions to compute distances between regions and transportation hubs, to determine inclusion relationships between points and polygons, and to compute adjacency relationships. By performing these computations on the server, the system reduces the need for repetitive spatial processing on the terminal and ensures consistent evaluation of spatial relationships.

The server uses the statistical and machine-learning module to estimate latent user preference by associating user preference feature information with region feature information. In one embodiment, the server trains a supervised learning model that predicts a preference score for a (user, region) pair. The server may use a neural network model having, for example, multiple fully-connected layers with non-linear activation functions. The first layer of the neural network receives as input a concatenation of the user feature vector and the region feature vector. Hidden layers apply weighted sums and activation functions such as rectified linear units. The output layer produces a scalar score representing a predicted preference degree. The server trains this neural network using historical interaction data, such as whether a user selected or accepted a proposed region, and minimizes a loss function such as mean squared error or cross-entropy using a gradient-based optimization algorithm. The server updates weights of the neural network through backpropagation until convergence criteria are satisfied. The server can alternatively use other models such as gradient boosting or factorization machines, depending on the data characteristics.

The server uses the emotion analysis module to estimate an emotion state for each region or facility. The server receives user-generated text, such as comments about regions or facilities and free-form explanations of user feelings. The server applies a natural language processing pipeline, which may include tokenization, part-of-speech tagging, and sentiment scoring. In one embodiment, the server uses a neural network-based classifier, such as a transformer-based sequence model, that has been trained on labeled emotion data. The model receives tokenized user text and outputs probabilities for emotion categories such as positive, negative, neutral, stress, or satisfaction. The server aggregates emotion scores per region or facility by computing weighted averages or time-decayed statistics. The server stores emotion states in association with region identifiers and facility identifiers.

The server weights user preference feature information and candidate region selection based on the emotion state. For example, the server increases the weight of regions associated with positive emotion states and decreases the weight of regions associated with negative emotion states. The server modifies the input or output of the machine-learning model by multiplying region feature vectors or predicted scores with emotion-based factors. This causes the prediction process to dynamically adapt to changes in user emotion, improving the alignment between computed scores and the user's current affective context.

The server uses the geographic information processing module together with the predicted preference scores and emotion-weighted scores to select candidate regions and candidate transportation hubs. The server executes spatial queries to identify transportation hubs in proximity to high-scoring regions. The server may, for example, find for each region the nearest transportation hub within a threshold distance, and compute an accessibility score based on travel time or network distance. The server combines accessibility scores with preference scores to obtain a composite score for each (region, transportation hub) pair. The server then selects top-scoring pairs as candidates for recommendation.

The server generates explanatory data that summarizes user preference feature information, latent user preference, candidate regions, candidate transportation hubs, and numerical indices related thereto. The server constructs internal data structures, such as objects or records, that contain feature values, scores, and identifiers. The server converts these into a compact human-interpretable representation, for example a textual bullet list describing each candidate region and transportation hub with associated metrics. The explanatory data is prepared in a way that makes it suitable for inclusion in a prompt sentence for a generative AI model.

The server uses the prompt generation module to automatically generate a prompt sentence. The server formats summary information, including user preference feature information, emotion state, region feature information, and spatial relationships of candidate transportation hubs, into a text form interpretable by the generative AI model. The server may use string templates with placeholders to systematically insert numerical and categorical values into a natural-language template. Because the prompt is created from structured internal data, it consistently reflects the current state of the server's computations. In one example related to residential recommendations, the server generates a prompt sentence such as:

“The user prefers a quiet environment, high safety, and access to cafes.

User's behavior summary: frequent cafe visits, rare nightlife visits.

Candidate regions:
Area A: safety score 0.9, cafe density high, noise level low.
Area B: safety score 0.8, cafe density medium, noise level medium.
Area C: safety score 0.7, cafe density very high, noise level high.

Considering the user's preferences and the data above, list 3 recommended residential areas and their nearest stations. Explain briefly why each area is suitable for this user.”

In another example related to product recommendations, the server generates a prompt sentence such as:

“User's past purchase history: running shoes, sports watch, yoga mat.

User's browsing history: fitness wear, training guides.

Based on this behavior, generate a list of 10 products that match the user's interests. For each product, provide a short reason.”

The server uses the generative AI interaction module to transmit the prompt sentence to a generative AI model. In one embodiment, the generative AI model is implemented as a large neural network with multiple layers of self-attention and feed-forward components, trained on a large corpus of text to predict the next token given a context. The server communicates with the generative AI model over a network using an application programming interface. The server supplies the prompt sentence as input tokens and specifies parameters such as maximum output length and sampling strategy. The generative AI model performs internal computations, including attention-based weighting of the prompt tokens and generation of candidate tokens based on learned probability distributions.

The server receives a proposal result in natural language from the generative AI model. The proposal result may contain rankings of candidate regions and transportation hubs, natural-language explanations of why each option is suitable, and suggestions for additional options. The server parses the proposal result to identify references to regions and transportation hubs, and verifies that these references correspond to known identifiers stored in the database. If necessary, the server resolves ambiguous names by matching them with the closest candidate in the explanatory data. The server then associates each narrative explanation with the corresponding region and transportation hub.

The server uses the recommendation assembly module to integrate the proposal result with numerical indices and internal scores. The server creates recommendation information that includes, for each recommended item, its identifier, name, composite score, individual metrics such as safety score and facility density, and the narrative explanation from the generative AI model. The server serializes this recommendation information into a structured response. The server then causes a user interface on the terminal to display the recommendation information. The terminal displays a ranked list of regions and transportation hubs, along with maps and charts, and the associated explanatory text. The user can select an item to view more detailed information.

The server thereby improves computer technology in several ways. Because the server unifies feature generation, statistical and machine-learning processing, geographic information processing, emotion analysis, and prompt generation within a single coherent pipeline, the server reduces redundant transformations and accelerates computation. The use of normalized feature structures and precomputed spatial indices reduces the time required to query region and facility data. The weighting of scores by emotion state reduces noise in the preference estimation and leads to smaller variance in prediction errors. The automatic construction of prompt sentences from structured internal data reduces the size and complexity of data transmitted to the generative AI model compared to raw data transfer, thereby reducing network load and latency.

Furthermore, the system does not simply automate human decision-making; instead, the system uses internal numerical feature representations and non-intuitive, machine-optimized learning algorithms that cannot be practically replicated by manual procedures. For example, the neural network models use high-dimensional embeddings and non-linear activations, and the geographic module uses spatial indices and geometric predicates that exploit processor cache locality and parallelism. The combination of these components results in improved throughput, allowing the server to process many users concurrently with bounded latency.

In one alternative embodiment, the server replaces the neural network with a tree-based ensemble model. In such a case, the server still generates user preference feature information and region feature information but uses decision tree ensembles to compute preference scores. These models perform non-linear partitioning of the feature space, resulting in efficient inference with small memory footprint. The server may also modify the geographic information processing module to operate with different spatial resolution levels, for example switching between coarse-grained and fine-grained regions depending on available computational resources. The server may further use different emotion analysis techniques, such as rule-based lexicon methods or hybrid models, depending on privacy constraints or deployment requirements.

In another embodiment, the server extends the system to handle additional facility types, such as educational institutions or medical facilities. The server modifies region feature vectors to include counts and densities of these facility types, and re-trains the machine-learning model with updated labels reflecting user interactions with these new categories. The prompt generation module is configured to include new attributes in prompt sentences, ensuring that the generative AI model receives the updated context. For example, the server may generate a prompt sentence such as:

“The user prefers a safe area with many schools and clinics.

Candidate regions:
Area D: safety score 0.85, school density high, clinic density medium.
Area E: safety score 0.92, school density medium, clinic density high.

Recommend regions that best match the user's preferences and explain your reasoning.”

Through these embodiments, the system offers a flexible yet technically grounded framework for generating recommendations with improved accuracy and computational efficiency. The server uses specific data structures, such as fixed-length feature vectors, spatial indices, and explanatory data records, and uses explicit algorithms, such as gradient-based neural network training, spatial joins, and emotion-weighted scoring. The integration of these components into a single pipeline enables more precise control of data flow and reduces the overhead associated with separate subsystems. This results in a tangible improvement in the performance and reliability of computer-implemented recommendation services.

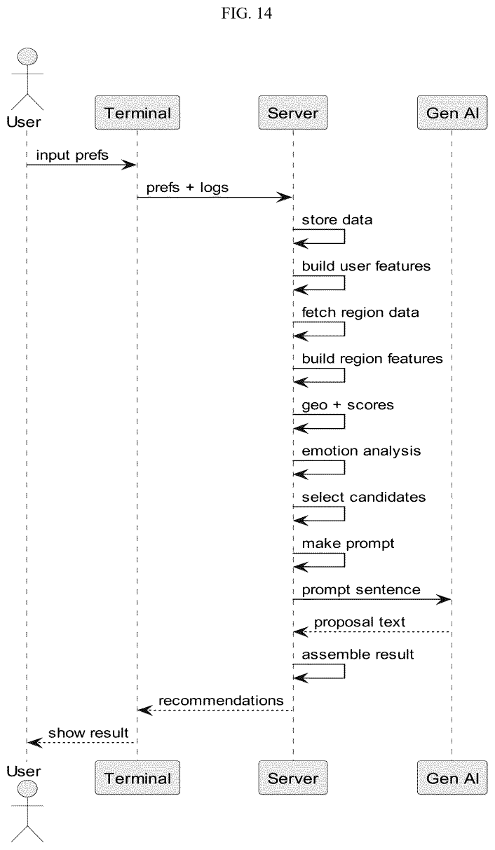

The following describes the processing flow using FIG. 14.

### Step 1

The user operates the terminal to input preference conditions and consent for data usage.

The input is text and selection data such as desired safety level, desired quietness, preferred facility categories, budget range, and checkboxes or sliders for constraints.

The terminal converts these user inputs into a structured internal representation, for example key-value pairs, and stores them temporarily in local memory.

The terminal outputs the structured preference conditions and a user identifier as a request payload to the server via a network connection.

### Step 2

The terminal sends behavioral information and usage history information to the server.

The input is locally stored logs, including visited locations (e.g., GPS coordinates and timestamps), accessed screens, clicked recommendation items, and simple purchase or selection events, associated with the user identifier.

The terminal packages these logs into a structured format, attaches timestamp and device information, and transmits them together with the preference conditions to the server using a secure communication protocol.

The terminal outputs a network message that contains user preference conditions, behavioral information, and usage history information.

### Step 3

The server receives and stores the user-related data.

The input is the network message from the terminal containing the user identifier, preference conditions, behavioral information, and usage history information.

The server validates the message format, parses the content into separate data objects, and performs basic error checking such as type validation and range checks.

The server writes the preference conditions into a user profile table, writes behavioral information into a behavior log table, and writes usage history information into a usage history table in a database.

The server outputs persistent records that are indexed by the user identifier and available for later queries.

### Step 4

The server generates user preference feature information.

The input is the stored behavioral information, usage history information, and preference conditions for a given user identifier.

The server aggregates behavior logs by category (e.g., counts of cafe visits, counts of park visits, counts of nightlife visits), computes temporal features (e.g., average visit time of day), and extracts binary indicators from explicit preferences (e.g., “prefers quiet=1”).

The server normalizes continuous values using methods such as min-max scaling or z-score normalization and encodes categorical variables into numeric vectors by one-hot encoding or index mapping.

The server outputs a fixed-length numerical feature vector representing the user preference feature information.

### Step 5

The server collects and updates region information and facility information from multiple information sources.

The input is configuration metadata indicating target information sources (public databases, review sites, mapping services) and region identifiers or geographic areas of interest.

The server calls external application programming interfaces and downloads documents or responses that contain raw region information such as crime statistics, demographic data, and zoning labels, and facility information such as establishment categories, ratings, and opening dates.

The server parses each response, extracts relevant attributes, unifies attribute names into a common schema, and associates each record with a region identifier and geographic coordinates.

The server outputs normalized tables of region information and facility information stored in the database.

### Step 6

The server generates region feature information.

The input is the normalized region information and facility information associated with each region identifier.

The server groups facilities by region, counts facilities by category, and divides these counts by region area to obtain facility densities; the server also calculates statistics such as average rating, median price level, and minimum distance to certain facility types.

The server combines these metrics with region-level attributes such as crime rate and noise index, and normalizes all metrics to a standard numerical range.

The server outputs a region feature vector for each region, with consistent dimension ordering and value scaling across all regions.

### Step 7

The server performs geographic information processing and associates regions with transportation hubs.

The input is region geometries, facility coordinates, and known transportation hub locations, together with the region feature information.

The server uses spatial indexing and geometric functions to determine which hubs are nearest to each region, calculates distances, and computes accessibility scores such as estimated travel times or connectivity indices.

The server augments the region feature vectors with these accessibility scores and stores mapping relationships between region identifiers and transportation hub identifiers.

The server outputs enhanced region feature information and a table of candidate region-transportation hub pairs.

### Step 8

The server estimates latent user preference for each region.

The input is the user preference feature information for a specified user and the region feature information for all regions.

The server uses a machine-learning model, such as a neural network with fully-connected layers, that takes as input a concatenation of a user feature vector and a region feature vector, processes them through weighted sums and activation functions, and produces a scalar score predicting the user's preference for that region.

The server applies this model to all regions to compute a preference score distribution, optionally using batch processing and vectorized operations for efficiency.

The server outputs a list of regions with associated latent preference scores for the given user.

### Step 9

The server performs emotion analysis and updates emotion states.

The input is user-generated text such as comments or free-form queries, and behavioral information relating to specific regions or facilities.

The server applies a text-processing pipeline that tokenizes the text, feeds token sequences into an emotion classification model (e.g., a transformer-based neural network), and obtains probabilities for emotion categories such as positive, negative, stress, and satisfaction.

The server aggregates emotion probabilities for each region or facility, applies time decay to older entries, and calculates an emotion state score per region and a global emotion state for the user.

The server outputs emotion state records associated with region identifiers and a global emotion state entry stored in the user profile.

### Step 10

The server generates emotion-weighted scores and selects candidate regions and transportation hubs.

The input is the latent preference scores per region and the emotion state per region or facility, as well as the mapping between regions and transportation hubs.

The server computes a combined score for each region by multiplying or otherwise combining the latent preference score with an emotion weight factor derived from the emotion state, and then adds accessibility scores for transportation hubs to derive composite scores for region-hub pairs.

The server ranks region-hub pairs according to the composite scores and selects top-ranked pairs that satisfy threshold constraints such as minimum safety score or facility density.

The server outputs a set of candidate regions and candidate transportation hubs with associated composite scores and detailed metrics.

### Step 11

The server constructs explanatory data for the candidate regions and transportation hubs.

The input is the user preference feature information, the latent preference scores, the emotion-weighted composite scores, the region feature information, and the mapping between regions and transportation hubs.

The server creates a compact representation for each candidate that includes region name or identifier, transportation hub name or identifier, safety score, key facility densities, emotion state summary, and composite score.

The server organizes these per-candidate records into a list ordered by composite score and formats numerical values to human-readable precision.

The server outputs explanatory data structures ready for transformation into a natural-language context.

### Step 12

The server generates a prompt sentence for a generative AI model.

The input is the explanatory data and the current user preference conditions.

The server assembles a prompt sentence by inserting values from the explanatory data into a natural-language template, for example creating a paragraph that describes the user's preferences and bullet-style lines describing each candidate region and hub with their metrics.

The server ensures that the prompt sentence includes sufficient context for the generative AI model to understand the task, such as an explicit instruction to recommend and explain specific numbers of regions.

The server outputs a prompt sentence in plain text that encodes structured data and instructions for the generative AI model.

### Step 13

The server sends the prompt sentence to the generative AI model and receives a proposal result.

The input is the prompt sentence generated in Step 12 and configuration parameters such as maximum output length and randomness level.

The server transmits the prompt sentence to the generative AI model interface, waits for completion of inference, and receives generated text that typically contains ranked recommendations, names of regions or hubs, and natural-language explanations.

The server parses the generated text to identify candidate references, extracts explanation segments, and checks consistency with the previously selected candidate list.

The server outputs a normalized proposal result that associates each generated explanation with a specific candidate region-hub pair.

### Step 14

The server assembles final recommendation information.

The input is the normalized proposal result from the generative AI model and the numerical indices and metrics used in prior computations.

The server merges AI-generated explanations with numeric scores and metrics, creates structured recommendation items that include identifiers, display names, composite scores, key statistics, and explanation strings, and orders them according to rank.

The server optionally truncates or reformats explanations to fit presentation constraints and attaches metadata such as timestamps and version numbers.

The server outputs a response payload containing the final recommendation information ready for delivery to the terminal.

### Step 15

The terminal receives and displays the recommendation information to the user.

The input is the response payload from the server, including structured recommendation items for regions, transportation hubs, and optionally facilities or products.

The terminal parses the payload, populates user interface components such as lists, maps, and detail views, and renders each recommendation with both numerical indicators and the natural-language explanation obtained from the generative AI model.

The terminal may allow the user to scroll through the recommendations, tap on items for more details, and view additional visualizations such as charts or route maps.

The terminal outputs human-perceivable content on a display, enabling the user to review and act upon the recommendations.

### Step 16

The user interacts with the recommendations and provides implicit feedback.

The input is the displayed recommendation information on the terminal's user interface.

The user selects certain recommended items, ignores others, spends varying amounts of time on different detail pages, and may enter additional comments or refine preference conditions.

The terminal detects these interactions as events, logs them as additional behavioral information and usage history information, and associates them with the corresponding recommendation identifiers and timestamps.

The terminal outputs updated logs back to the server, enabling the server to refine user preference feature information and improve future recommendations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

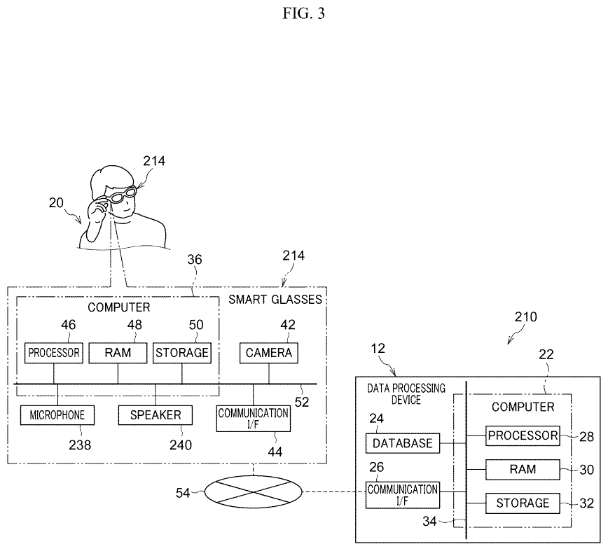

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

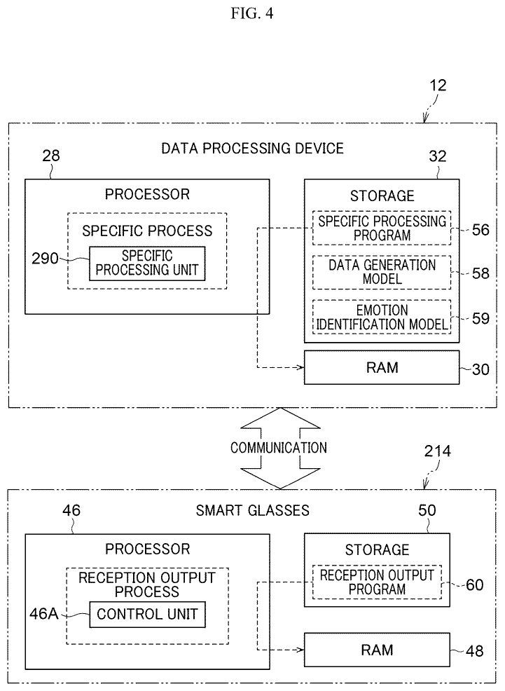

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

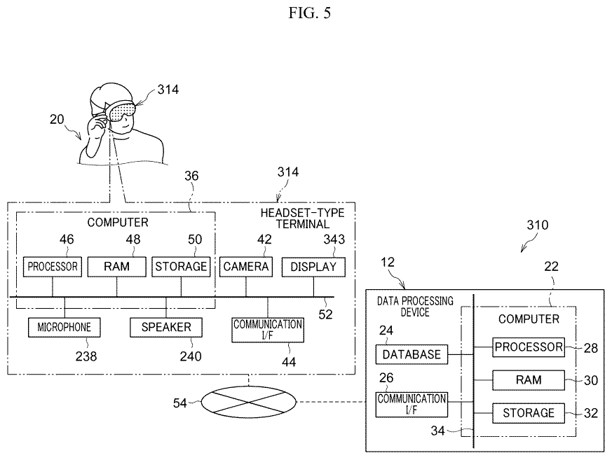

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

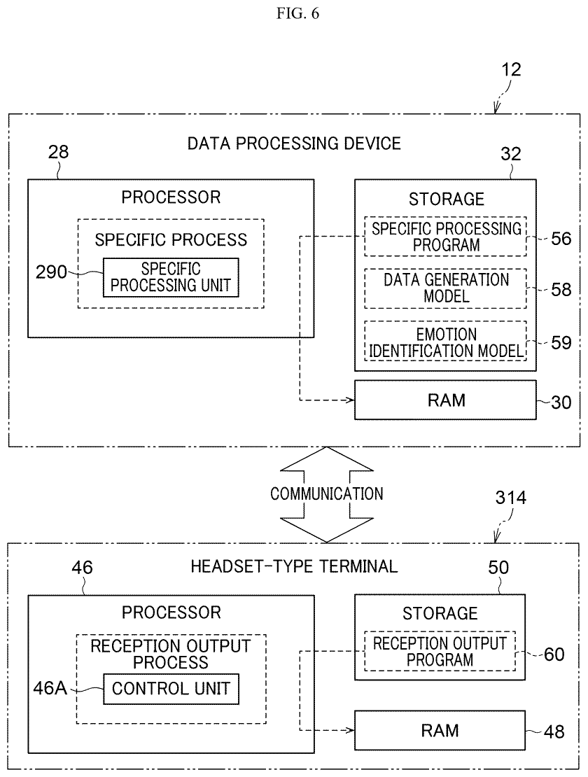

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

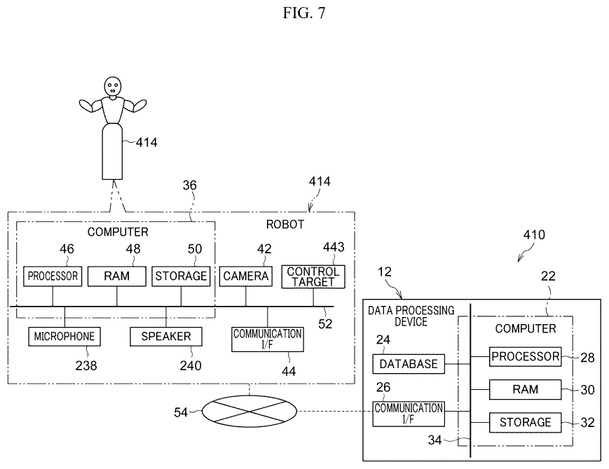

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

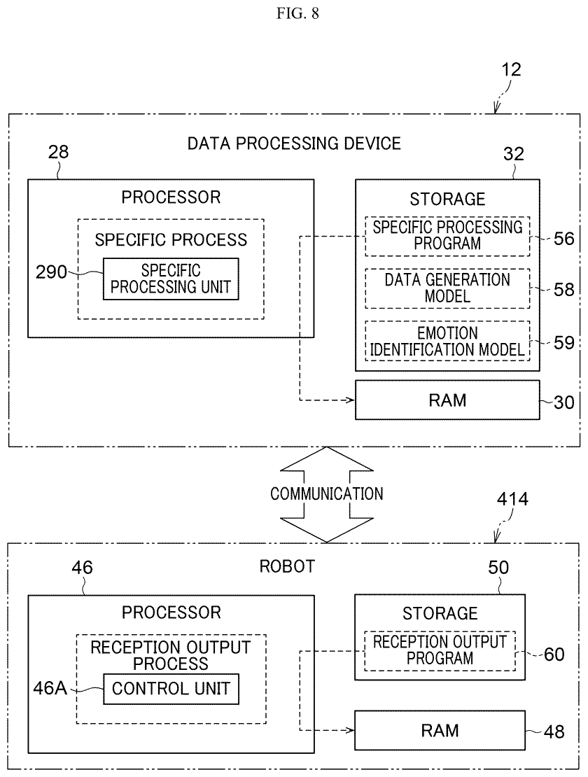

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

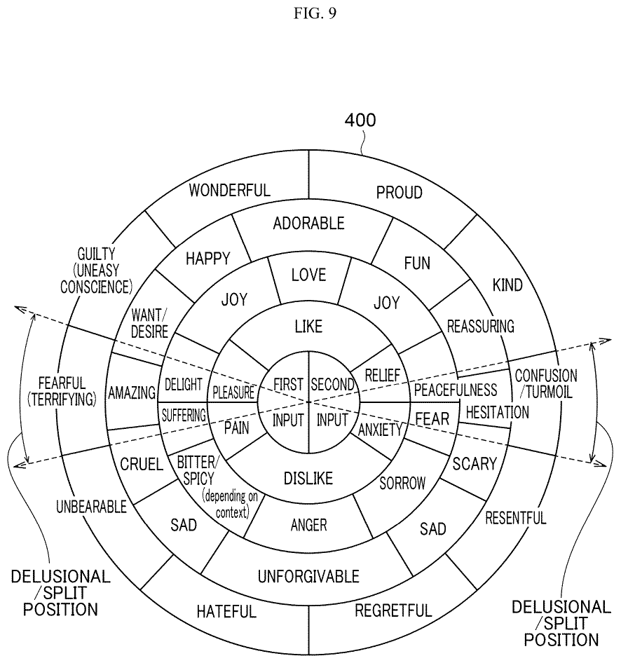

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

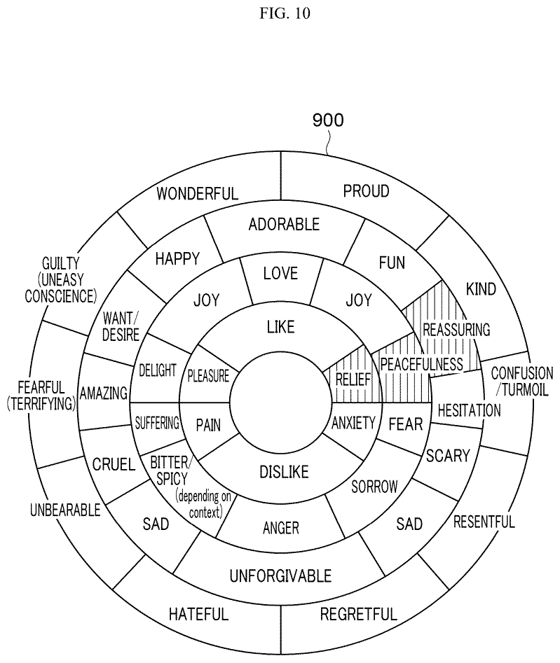

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive input information regarding residential conditions from a user and acquire the input information as structured data,
acquire raw region-related data from a plurality of external information sources via a communication network based on the structured data,
generate feature data on a region basis by calculating, from the raw data, a safety index based on crime occurrence information, aggregating a number of facilities opened within a predetermined period based on commercial facility information, and integrating the safety index and the aggregated number of facilities,
generate, for each region, a feature vector including a weighted composite value based on the feature data and the input information from the user, and generate a prompt sentence including the feature vector and natural language describing residential conditions of the user,
input the prompt sentence to a generative AI model to obtain prediction result data that ranks a plurality of regions included in the feature data according to a degree of suitability for the residential conditions of the user and includes an explanatory reason for each region, and
generate proposal result data by associating the prediction result data with the feature data so as to include, for each recommended region, the safety index and the aggregated number of commercial facilities, and cause a user interface to display the proposal result data.

### Supplementary 2

The system according to supplementary 1,
wherein the processor is configured to
include, in the structured data, a free-description text by the user, numerical parameters, and weight information indicating importance of each evaluation item, and to reflect the weight information in both calculation of the weighted composite value for the feature data and generation of the prompt sentence.

### Supplementary 3

The system according to supplementary 1,
wherein the processor is configured to
include, in the prompt sentence, a machine-readable structured description representing the feature vector and an instruction sentence specifying a ranking format and an explanatory-reason format for regions to the generative AI model, obtain machine-readable output data including a region name, a rank, and an explanatory reason from the generative AI model, and analyze the output data to generate the proposal result data.

### Application Example 1

### Supplementary 1

A system comprising a processor,
wherein the processor is configured to
receive input information from a user including preference conditions regarding a living environment or a business facility location and conditions regarding a target customer group,
extract reference items corresponding to the preference conditions and the target customer group from the input information, and generate inquiry information based on the reference items,
acquire, via a communication network from a plurality of information sources, environment-related data including regional safety information, new business facility information, retail outlet information, and price level information on the basis of the inquiry information,
perform normalization processing, feature extraction processing, and attribute assignment processing on the environment-related data, and generate integrated feature data for each candidate area,
generate a prompt sentence for predicting candidate areas or candidate business facility locations that are optimal for the conditions of the user, based on the integrated feature data and the preference conditions,
input the prompt sentence and the integrated feature data into a generative information processing model, cause the generative information processing model to execute computational processing including matrix operations and nonlinear transformations, and thereby obtain a prediction result indicating a suitability level for the candidate areas or the candidate business facility locations,
rank the candidate areas or the candidate business facility locations based on the prediction result, and generate explanation information for each candidate including a safety index, a concentration level of new business facilities, a merchandise assortment of retail outlets, and a price range, and
output, to a user display screen, a proposal result including the explanation information.

### Supplementary 2

The system according to supplementary 1,
wherein the processor is configured to analyze the input information obtained from the user by natural language processing to extract internal attribute information representing constraint conditions relating to safety, business facility density, retail outlet characteristics, and price level, to construct the prompt sentence using the internal attribute information, and to associate the internal attribute information with the integrated feature data and input the associated information into the generative information processing model.

### Supplementary 3

The system according to supplementary 1,
wherein the processor is configured to associate the environment-related data acquired from the plurality of information sources with candidate area identification information or area codes, to integrate the environment-related data, to perform correction processing based on a weighted average or a reliability level when conflicting data exist, and to generate the integrated feature data after the correction processing, and to use the integrated feature data to input the prompt sentence into the generative information processing model and obtain the prediction result.

### Example 2

### Supplementary 1

A system comprising a processor,
wherein the processor is configured to
acquire, from a user terminal via a communication network, user input information and behavior history information including location information and purchase history information, and store the behavior history information in a behavior history storage area of a storage device,
preprocess the behavior history information stored in the behavior history storage area by using data analysis software to perform at least deletion of duplicate data, completion of missing values, removal of abnormal values, and aggregation processing, and generate behavior feature data for each user,
execute, by using machine learning software, a classification process or a clustering process on the behavior feature data to estimate user preference information including at least one of sightseeing orientation, imaging orientation, urban orientation, and quietness orientation, and
record the estimated user preference information in a preference storage area,
acquire, via the communication network from an external information providing device, region-related information including at least regional statistical information, real-estate information, and evaluation information, and store the region-related information in a region information storage area,
calculate, by using numerical computation software, a suitability index for each candidate region based on the user preference information recorded in the preference storage area and the region-related information stored in the region information storage area, and specify a candidate region suitable for the user based on the suitability index,
generate structured data including at least the user preference information, the region-related information, and the candidate region, and generate a prompt sentence including the structured data and instructing a generative AI model to describe candidate regions that satisfy user conditions,
input the prompt sentence and the structured data into the generative AI model and obtain, from the generative AI model, an explanation result in a natural language including at least a selection reason of the candidate region and an explanation of the user preference, and
transmit the candidate region, the suitability index, and the explanation result to the user terminal via the communication network and cause the user terminal to display the candidate region, the suitability index, and the explanation result through a user interface.

### Supplementary 2

The system according to supplementary 1,
wherein the processor is configured to
update the user preference information based on explicit input information of the user acquired through the user interface, the behavior history information stored in the behavior history storage area, and evaluation information regarding recommendation results transmitted from the user terminal, and regenerate the prompt sentence based on the updated user preference information.

### Supplementary 3

The system according to supplementary 1,
wherein the processor is configured to
embed, when generating the prompt sentence, a data block including at least the behavior feature data, the user preference information, the suitability index of the candidate region, and the region-related information in the prompt sentence in a text format or a hierarchical structured data format, and include in the prompt sentence an instruction that the generative AI model generate, with reference to the data block, a description sentence of the candidate region and a summary sentence of the user preference.

### Application Example 2

### Supplementary 1

A system comprising a processor,
wherein the processor is configured to
acquire preference conditions and behavioral information from a user and usage history information from a terminal,
generate user preference feature information based on the behavioral information and the usage history information,
obtain region information and facility information from a plurality of information sources via a network and convert the region information and the facility information into numerical and normalized region feature information,
estimate latent user preference by associating the user preference feature information with the region feature information using statistical processing or machine learning processing,
assign spatial information to the region feature information using a geographic information processing function and select candidate regions and candidate transportation hubs based on the latent user preference,
generate explanatory data including the user preference feature information, the latent user preference, the candidate regions, the candidate transportation hubs, and numerical indices related thereto,
construct a prompt sentence based on the explanatory data for causing a generative AI model to perform prediction and explanation regarding the candidate regions and the candidate transportation hubs,
input the prompt sentence to the generative AI model and obtain a proposal result in natural language regarding the candidate regions and the candidate transportation hubs from the generative AI model, and
integrate the proposal result with the numerical indices to form recommendation information and cause a user interface to display the recommendation information.

### Supplementary 2

The system according to supplementary 1,
wherein the processor is configured to
perform emotion analysis on user behavior history data and user text input to estimate an emotion state for each region or facility, and weight at least one of the user preference feature information and the selection of the candidate regions based on the emotion state.

### Supplementary 3

The system according to supplementary 1,
wherein the processor is configured to
automatically format summary information including the user preference feature information, the emotion state, the region feature information, and spatial relationships of the candidate transportation hubs into a text form interpretable by the generative AI model, and generate the prompt sentence including the summary information.

What is claimed is:

1. A system comprising:
circuitry configured to
receive, via a communication interface coupled to a packet-switched network, condition data from a terminal device, the condition data comprising structured data including free-text input, numerical parameters, and weight values for a plurality of evaluation items,
acquire, via the communication interface, raw data from a plurality of external information sources based on the condition data, the raw data comprising at least occurrence frequency data and facility attribute data associated with a plurality of geographic entities,
generate entity-level feature data by computing a quantitative safety index from the occurrence frequency data and aggregating facility counts within a predetermined temporal period from the facility attribute data, and integrating the quantitative safety index and the aggregated facility counts for each geographic entity,
generate, for each geographic entity, a feature vector comprising a weighted composite value by applying the weight values from the condition data to the entity-level feature data,
generate a structured prompt data structure comprising a machine-readable description of the feature vector and a natural language description of the condition data, the structured prompt data structure further comprising instructions specifying a ranking format and an explanatory-reason format,
input the structured prompt data structure into a generative neural network model and obtain prediction result data comprising, for each of a plurality of geographic entities, an entity identifier, a rank value, and explanatory reason data,
parse the prediction result data and associate the prediction result data with the entity-level feature data to generate proposal result data comprising, for each ranked geographic entity, the quantitative safety index, the aggregated facility counts, and the explanatory reason data, and
transmit, via the communication interface, display data representing the proposal result data to the terminal device for presentation.

2. The system according to claim 1, wherein the circuitry is further configured to estimate a preference profile of the user based on at least one of the condition data directly input by the user and behavior history data stored in a storage device, and generate the structured prompt data structure based on the estimated preference profile.

3. The system according to claim 2, wherein the behavior history data comprises prior interaction records, prior search query data, and prior selection data, and the circuitry applies a collaborative filtering model or a content-based filtering model to the behavior history data to compute implicit preference scores for the evaluation items.

4. The system according to claim 3, wherein the circuitry is further configured to combine the implicit preference scores with the weight values explicitly provided in the condition data using a weighted fusion function, and use the fused weight values to compute the feature vectors.

5. The system according to claim 1, wherein the plurality of external information sources comprise at least a public statistical data source, a social media data source, a review data source, and a geographic attribute data source, and the circuitry applies source-specific parsing operations to normalize the raw data into a unified schema prior to computing the entity-level feature data.

6. The system according to claim 5, wherein the circuitry is further configured to apply temporal filtering to the raw data to select data records within a predetermined recency window, and weight more recent data records more heavily in the feature data computation.

7. The system according to claim 6, wherein the circuitry is further configured to apply a sentiment analysis model to text data from the social media data source and the review data source to compute a sentiment score for each geographic entity, and include the sentiment score in the entity-level feature data.

8. The system according to claim 1, wherein the machine-readable description of the feature vector in the structured prompt data structure comprises a tabular encoding with column headers identifying evaluation item names and row entries identifying geographic entity identifiers and corresponding weighted composite values.

9. The system according to claim 8, wherein the instructions in the structured prompt data structure further specify a maximum count of geographic entities to rank, a minimum threshold for the weighted composite value, and a constraint on the length of the explanatory reason data.

10. The system according to claim 1, wherein the circuitry is further configured to perform a post-processing validation on the prediction result data by verifying that the rank values are consistent with a descending order of the weighted composite values, and, upon detecting inconsistency, re-input a correction prompt data structure into the generative neural network model.

11. The system according to claim 10, wherein the correction prompt data structure comprises the original structured prompt data structure appended with a constraint emphasis specifying that ranking must be consistent with the weighted composite values.

12. The system according to claim 1, wherein the display data comprises an interactive map visualization in which the ranked geographic entities are displayed at corresponding geographic coordinates with visual indicators proportional to the rank values.

13. The system according to claim 12, wherein the display data further comprises selectable detail panels for each ranked geographic entity, each detail panel displaying the quantitative safety index, the aggregated facility counts, the explanatory reason data, and supplemental attribute data derived from the raw data.

14. The system according to claim 1, wherein the circuitry is further configured to receive feedback data from the terminal device indicating user acceptance or rejection of one or more ranked geographic entities, and store the feedback data in association with the condition data and the prediction result data for refining the weight values or the structured prompt data structure in subsequent interactions.

15. The system according to claim 14, wherein the circuitry is further configured to retrain or fine-tune a weight adjustment model based on accumulated feedback data to improve alignment between the weighted composite values and user acceptance patterns.

16. The system according to claim 1, wherein the geographic entities comprise residential area regions, and the entity-level feature data further comprises transportation accessibility scores, educational facility proximity scores, and environmental quality indices.

17. The system according to claim 16, wherein the explanatory reason data generated by the generative neural network model comprises natural language descriptions identifying specific strengths and weaknesses of each ranked residential area region relative to the condition data.

18. A system comprising:
circuitry configured to
receive, via a communication interface coupled to a packet-switched network, condition data from a terminal device comprising numerical parameters and weight values for evaluation items,
acquire raw data from a plurality of external information sources via the communication interface, compute entity-level feature data including a quantitative safety index and aggregated facility counts for each of a plurality of geographic entities, and generate feature vectors by applying the weight values to the entity-level feature data,
generate a structured prompt data structure comprising a machine-readable feature vector description and natural language condition description with ranking and explanatory-reason format instructions, input the structured prompt data structure into a generative neural network model, and obtain prediction result data comprising entity identifiers, rank values, and explanatory reason data,
parse the prediction result data, associate it with the entity-level feature data to generate proposal result data, validate ranking consistency against the weighted composite values, and transmit display data to the terminal device, and
receive feedback data from the terminal device, store the feedback data in association with the condition data and prediction result data, and update weight parameters or prompt generation logic based on the feedback data.

19. The system according to claim 18, wherein the circuitry is further configured to estimate implicit preferences from behavior history data using a collaborative filtering or content-based filtering model, and fuse the implicit preferences with the explicitly provided weight values using a weighted fusion function.

20. A method comprising:
receiving, via a communication interface coupled to a packet-switched network, condition data from a terminal device comprising structured data including free-text input, numerical parameters, and weight values for evaluation items;
acquiring raw data from a plurality of external information sources via the communication interface based on the condition data;
generating entity-level feature data by computing a quantitative safety index from occurrence frequency data and aggregating facility counts from facility attribute data for each of a plurality of geographic entities;
generating feature vectors by applying the weight values to the entity-level feature data;
generating a structured prompt data structure comprising a machine-readable feature vector description and a natural language condition description with ranking format instructions;
inputting the structured prompt data structure into a generative neural network model and obtaining prediction result data comprising entity identifiers, rank values, and explanatory reason data;
parsing the prediction result data and associating the prediction result data with the entity-level feature data to generate proposal result data; and
transmitting display data representing the proposal result data to the terminal device via the communication interface.
